(19) United States
(12) Patent Application Publication
(10) Pub. No.: US 2024/0036965 A1
(43) Pub. Date: Feb. 1, 2024

(54) AUTOMATED REMEDIATION OF ISSUES ARISING IN A DATA MANAGEMENT STORAGE SOLUTION

(71) Applicant: NetApp, Inc., San Jose, CA (US)

(72) Inventors: Nibu Habel, Bangalore (IN); Jeffrey Scott MacFarland, Wake Forest, NC (US); John Richard Swift, Ontario (CA)

(73) Assignee: NetApp, Inc., San Jose, CA (US)

(21) Appl. No.: 18/301,091

(22) Filed: Apr. 14, 2023

(30) Foreign Application Priority Data
Jul. 27, 2022 (IN) 202241043049

(51) Int. Cl. G06F 11/07; G06F 11/30

(52) U.S. Cl. CPC G06F 11/079; G06F 11/0793; G06F 11/3034

(57) ABSTRACT

Systems and methods for automated remediation of issues arising in a data management storage system are provided. Deployed assets of a storage solution vendor may deliver telemetry data to the vendor on a regular basis. The received telemetry data may be processed by an AIOps platform to perform predictive analytics and arrive at “community wisdom” from the vendor's installed user base. In one embodiment, an insight-based approach is used to facilitate risk detection and remediation including proactively addressing issues before they turn into more serious problems. For example, based on continuous learning based on the community wisdom and making one or both of a rule set and a remediation set derived therefrom available for use by cognitive computing co-located with a customer's storage system, a risk to which the storage system is exposed may be determined and a corresponding remediation may be deployed to address or mitigate the risk.

### CROSS-REFERENCE TO RELATED APPLICATIONS

This application claims the benefit of Indian Provisional Application No. 202241043049, filed on Jul. 7, 2022, which is hereby incorporated by reference in its entirety for all purposes.

### FIELD

Various embodiments of the present disclosure generally relate to monitoring and remediation of the health of information technology (IT) equipment, clusters thereof, and/or services deployed within a private or public cloud, for example, running on virtual machines (VMs) or containers (or pods) managed by a container orchestration platform. In particular, some embodiments relate to an auto-healing feature that monitors events within a cluster of nodes representing a distributed data management storage system and facilitates automated remediation of issues by identifying corresponding appropriate courses of action.

### BACKGROUND

Data is the lifeblood of every business and must flow seamlessly to enable digital transformation, but companies can extract value from data only as quickly as the underlying infrastructure can manage it. Data centers and the applications they support are becoming more and more complex day-by-day. Issues arising in an on-premise or public cloud-based data management storage solution can have an adverse effect on an organization and can cause loss of revenue as a result of downtime. Troubleshooting issues and fixing them is often time consuming and exhausting and distracts users from other business objectives and customer service related tasks.

### SUMMARY

Systems and methods are described for automated remediation of issues arising in a data management storage system. According to one embodiment, the existence of a risk to which a data storage system is exposed is determined by evaluating conditions associated with a set of one or more rules that are indicative of a root cause of the risk. The set of one or more rules are part of a rule set that is derived at least in part based on community wisdom applicable to the data storage system. Existence of a remediation associated with the risk that addresses or mitigates the risk is then identified. One or more remediation actions are executed that implement the remediation.

Other features of embodiments of the present disclosure will be apparent from accompanying drawings and detailed description that follows.

### BRIEF DESCRIPTION OF THE DRAWINGS

The present disclosure is best understood from the following detailed description when read with the accompanying figures.

FIG. 1 is a block diagram illustrating a feedback loop through which a data management storage solution may be updated out-of-cycle with a release schedule for software of the data management storage solution in accordance with one or more embodiments.

FIG. 2 is a block diagram illustrating an example of a distributed storage system in accordance with one or more embodiments.

FIG. 3 is a block diagram illustrating an example on-premise environment in which various embodiments may be implemented.

FIG. 4 is a block diagram illustrating an example cloud environment in which various embodiments may be implemented.

FIG. 5 illustrates an example screen shot of a system manager dashboard in accordance with one or more embodiments.

FIG. 6 illustrates an example dialog box that may be presented by the system manager dashboard responsive to selection of the details button from the screen shot of FIG. 5 in accordance with one or more embodiments.

FIG. 7 illustrates another example screen shot of a system manager dashboard in accordance with one or more embodiments.

FIG. 8 illustrates an example dialog box that may be presented by the system manager dashboard responsive to selection of the details button from the screen shot of FIG. 7 in accordance with one or more embodiments.

FIG. 9 is a block diagram illustrating components of an auto-healing system that may be implemented within a node of a cluster in accordance with one or more embodiments.

FIG. 10A is an entity relationship diagram for rules and remediations in accordance with one or more embodiments.

FIG. 10B is an example of a rules table in accordance with one or more embodiments.

FIG. 11 is a flow diagram illustrating a set of operations for performing automated remediation in accordance with one or more embodiments.

FIG. 12 is a flow diagram illustrating as set of operations for performing pub/sub processing in accordance with one or more embodiments.

FIG. 13 is a flow diagram illustrating as set of operations for coordinating execution of rules and remediations in accordance with one or more embodiments.

FIG. 14 is a flow diagram illustrating as set of operations for performing rule execution in accordance with one or more embodiments.

FIG. 15 is a flow diagram illustrating as set of operations for performing remediation execution in accordance with one or more embodiments.

FIG. 16 is a block diagram illustrating an example of a network environment in accordance with one or more embodiments.

FIG. 17 illustrates an example computer system in which or with which embodiments of the present disclosure may be utilized.

The drawings have not necessarily been drawn to scale. Similarly, some components and/or operations may be separated into different blocks or combined into single blocks for the purposes of discussion of some embodiments of the present technology. Moreover, while the technology is amenable to various modifications and alternate forms, specific embodiments have been shown by way of example in the drawings and are described in detail below. The intention, however, is not to limit the technology to the particular embodiments described or shown. Rather, the technology is intended to cover all modifications, equivalents, and alternatives.

### DETAILED DESCRIPTION

Systems and methods are described for automated remediation of issues arising in a data management storage system. At present, some storage equipment and/or data management storage solution vendors monitor customer clusters using automated support (“ASUP”). For example, tens or hundreds of thousands of deployed assets (e.g., storage controllers) of a particular data management storage solution vendor may deliver ASUP telemetry data to the vendor on a regular basis. The received ASUP telemetry data may be added to a multi-petabyte data lake and processed through multiple machine-learning (ML) classification models to perform predictive analytics and arrive at “community wisdom” derived from the vendor's installed user base. Some storage equipment and/or data management storage solution vendors may allow administrative users of customers to log in via cloud-based portals to check for issues associated with their installation and then proceed with manual fixes based on the community wisdom. One drawback with such an approach is time. The time taken to fix an issue may be quite long, for example, depending upon the time between check-ins by the administrative user.

Various embodiments described herein seek to provide an insight-based approach to risk detection and remediation including more proactively addressing issues before they turn into more serious problems. For example, by continuously learning from the community wisdom and making it available for use by cognitive computing co-located with a customer's cluster, insights may be extracted from this data to deliver actionable intelligence.

The general idea behind some embodiments is to offer storage consumers insights into issues that are affecting their environment rather than an endless list of cryptic error events. For example, a set of one or more automated actions may be presented via a system manager dashboard as part of an alert to an administrative user that will facilitate maintaining the health and resiliency of the customer's cluster. As described further below, in one embodiment, various rich ML models may be moved local to customer clusters so as to facilitate the provision of proactive and real-time health analysis, notifications to customers, and automated remediation (auto healing). For example, a predefined or configurable set of EMS events may be used to trigger a deep analysis (e.g., via a rule engine) to identify the existence of a risk to the cluster or a node thereof. If so, an alert may be raised and presented via a system manager dashboard associated with the cluster. Alternatively, or additionally, some rules may be run by the rule engine on a periodic schedule. For example, a scheduler/job manager may execute rules on a schedule specified by the rules themselves. In this manner, active risks may be checked on a periodic basis (by re-running an associated rule) to determine if the risk condition still exists or has been resolved. Risks that are known to arise as a result of periodic changes may be good candidates for checking on a periodic schedule.

In one embodiment, auto heal functionality may be enabled by monitoring a data management storage solution or a data storage system thereof (e.g., the Data ONTAP storage operating system available from NetApp, Inc. of San Jose, CA) for key events via a publisher/subscriber pattern (e.g., a Pub/Sub bus) and signaling an analytic engine when an issue is identified based on an event. Identified issues may be further analyzed using the rich community wisdom and such analysis may be mapped to known rules to facilitate determination of a root cause and a corresponding appropriate course of action. An administrative user of the data management storage solution may then be notified via an event management system (EMS) of the issue (e.g., a risk, an error, or a failure) and potential corrective action (e.g., a remediation). Alerts may be provided in the form of an EMS stateful event (e.g., an EMS event that contains state information). The state information may include a corrective action identified for the issue at hand.

Depending upon the particular implementation, some issues may be automatically remediated, while others may be proactively brought to the attention of the administrative user and remediated upon receipt of authorization from the administrative user. Preferences relating to the desired type of remediation (e.g., automated vs. user activated) for various types of identified issues arising within the data management storage solution may be configured by the administrative user learned from historical interactions (e.g., dismissal of similar issues or approving automated application of a remediation for similar issues) with the administrative user, and/or based on community wisdom. For example, the administrative user may select automated remediation for issues/risks known to arise as a result of periodic changes to the environment in which the data management storage solution operates and/or to the configuration of the data management storage solution. Auto-healing data management storage solution nodes and/or the cluster adds customer value by monitoring and fixing (or at least mitigating) issues before they become more serious problems, thereby freeing administrative users from researching and implementing remediations and instead allowing them to spend time on more strategic objectives.

While for purposes of explanation, two specific examples of network attached storage (NAS) events and corresponding remediations are described herein, it is to be appreciated the methodologies described herein are broadly applicable to other types of events (e.g., storage area network (SAN) events, security issues, performance issues, capacity issues, and/or compliance issues). More broadly speaking, the methodologies described herein are applicable to any signaling event that can be associated with a rule that does the analysis and determines the corrective action. For example, the described approach can be applied to misconfiguration issues, environmental issues, security issues, performance issues, capacity issues, and/or compliance issues.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein “AutoSupport” or “ASUP” generally refers to a telemetry mechanism that proactively monitors the health of a cluster of nodes (e.g., implemented in physical or virtual form) and/or individual nodes of a data management storage solution.

As used herein “community wisdom” generally refers to data received from and/or derived from a user base of one or more products/services of a vendor. Community wisdom may be collected to acquire a deep knowledge base to which predictive analytics and cognitive computing may be applied to derive insight-driven rules for identifying exposure to particular risks and insight-driven remediations for addressing or mitigating such risks. In the context of the enterprise-data-storage market, even a one to two percent market share represents a massive user base from which billions of data points may be gathered by a vendor on a daily basis from potentially hundreds of thousands of data management storage solutions. Insights may be extracted from this data by or on behalf of the vendor with cloud-based analytics that combine predictive analytics and proactive support to deliver actionable intelligence. Community wisdom may be said to be relevant to or applicable to a particular data storage system when such community wisdom was received from a similar class (e.g., entry-level, midrange, or high-end), and/or type (e.g., on-premise, cloud, or hybrid) of data storage system. Other classifications may include, but are not limited to workload type (e.g., high throughput, read only, etc.), features that are enabled (e.g., snapshot, replication, data reduction, Internet small computer system interface (iSCSI) protocol), applications running on the storage controllers, hardware (e.g., serial-attached SCSI (SAS), serial advanced technology attachment (SATA), non-volatile memory express (NVMe) disks, cache adapter installed, network adapters, and so on), system-defined performance service level (e.g., extreme performance (extremely high throughput at a very low latency), performance (high throughput at a low latency), value (high storage capacity and moderate latency), extreme for database logs (maximum throughput at the lowest latency), extreme for database shared data (very high throughput at the lowest latency), extreme for database data (high throughput at the lowest latency)).

As described herein a “risk” may identify an issue within a cluster of nodes and/or individual nodes of a data management storage solution. A risk may be communicated to an auto-heal system as an alert (e.g., an EMS event that contains state information (an EMS stateful event)). In some embodiments, the state information contained within an EMS stateful event may include an associated corrective action (e.g., a remediation). In one embodiment, risk identification may be triggered responsive to a predefined or configurable set of EMS events, which may be referred to herein as key EMS events. Risk identification may additionally or alternatively be identified responsive to rules that are run on a periodic schedule.

As described herein a “remediation” generally represents corrective action(s) that may be used to resolve an identified risk. In some embodiments, in order to facilitate auto-healing, remediations may be comprised of Python code. In other cases, remediations may be provided in the form of detailed directions (e.g., similar to the type of guidance and/or direction that might be received via level 1 (L1) or level 2 (L2) technical support) to allow an administrative user to perform remediations manually. Non-limiting examples of remediation actions include configuration recommendations for a data management storage solution or node thereof, command recommendations to be issued to a data management storage solution or node thereof, for example, via a command-line interface (CLI) or graphical user interface (GUI).

As described herein “rules” may be used to identify risks within a cluster of nodes and/or individual nodes of a data management storage solution. In some examples, the rules may be represented in the form of self-contained Python file(s) that contain code to identify a given issue (risk). For example, a rule may include one or more conditions or conditional expressions involving the current or historical state (e.g., configuration and/or event data) of the cluster or individual nodes that when true are indicative of the cluster or an individual node being exposed to the given risk. In some embodiments, rules may be hierarchically organized in parent-child relationships, for example, with zero or more child rules depending from a parent rule. A rule may contain or otherwise be associated with information as to whether it can be remediated. If so, the rule may also contain or be associated with steps for remediating the issue and/or explaining how the issue can be remediated. In one embodiment, rules can be executed based on a trigger or a schedule. In the context of trigger-based rules, a publisher/subscriber bus message, for example, identifying the occurrence of a key EMS event may represent the source of a trigger and may be associated with one or more rules to be executed. In the context of schedule-based rules, a scheduler or job manager may execute a given rule in accordance with a schedule associated with the given rule.

### Example Feedback Loop

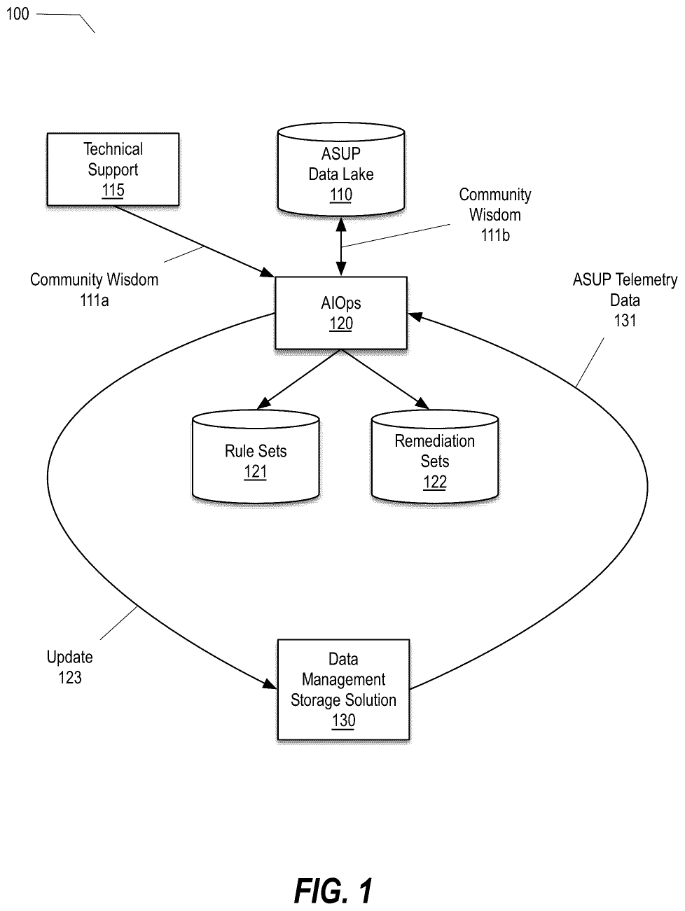

FIG. 1 is a block diagram illustrating a feedback loop through which a data management storage solution 130 may be updated out-of-cycle with a release schedule for software of the data management storage solution 130 in accordance with one or more embodiments. In the context of the present example, the feedback loop 100 includes technical support 115, an artificial intelligence for IT operations (AIOps) platform 120, and the data management storage solution 130. The data management storage solution 130 may be a cluster of one or more nodes, which may individually be referred to as a data storage system, and which may collectively represent a distributed storage system.

In general, the AIOps platform 120 may use big data, analytics, and ML to, among other things:
Collect and aggregate data generated by data management storage solutions (or components thereof) in use by thousands of, application demands, and performance-monitoring tools, and service ticketing systems.
Intelligently shift ‘signals’ out of the ‘noise’ to identify significant events and patterns related to existence of potential risks, application performance, and/or availability issues to which a given data management storage solution 130 may be exposed.
Diagnose root causes and report them to technical support staff, IT, and/or DevOps for rapid response and/or development of appropriate remediations that may be deployed to relevant portions of the customer base. Alternatively, in in some cases, the AIOps platform 120 may automatically propose remediations without human intervention.

According to one embodiment, the AIOps platform 120 represents a big data platform that aggregates community wisdom (e.g., community wisdom 11a-b) received from multiple sources (e.g., customers'/users' interactions with technical support staff (e.g., technical support 115), support case histories, and events associated with operation of data management storage solutions of participating customers having a feedback/reporting feature enabled). “AIOps” is an umbrella term for the use of big data analytics, ML, and/or other artificial intelligence (AI) technologies to automate the identification and resolution of common IT issues or risks. Separate rule sets 121 may be generated for different types and/or classes of data storage systems or based on features enabled within the data storage systems. Similarly, separate remediation sets 122 may be created for different types and/or classes of data storage systems or based on features enabled within the data storage systems. A non-limiting example of the AIOps platform 120 is the NetApp Active IQ Digital Advisor available from NetApp, Inc. of San Jose, CA.

The community wisdom may include, among other data:
Information regarding the type and class of the data storage system(s) at issue
Configuration (e.g., features that are enabled/disabled, the version of the storage operating system software being run, etc.) of the data management system(s) at issue
Feedback in the form of ML model predictions and scores
Historical performance and event data
Streaming real-time operations events
System logs and metrics
Network data, including packet data
Incident-related data and ticketing
Application demand data
Infrastructure data

Based on the community wisdom, the AIOps platform 120 may apply focused analytics and ML capabilities to, among other things:
Separate significant event alerts from the ‘noise’: The AIOps platform 120 may inspect, analyze, correlate and, evaluate the data to separate signals (e.g., significant abnormal event alerts) from noise (e.g., everything else).
Identify root causes and propose solutions: The AIOps platform 120 may correlate abnormal events or potential risks to which the data management storage solution 130 is exposed with other event data across environments to zero in on the cause of an issue, for example, a misconfiguration, an environmental issue (e.g., domain name system (DNS) change or network reconfiguration), a security issue, a performance issue, a capacity issue, or a compliance issue, and suggest remediations (e.g., step-by-step remediation actions) to address or mitigate the issue or potential risk. Root cause analyses may be used to determine the root cause of risks/issues/problems in order to facilitate identification of appropriate remediation actions. By identifying root causes, customer support teams can avoid unnecessary work involved with treating symptoms of the issue versus the core problem. For example, the AIOps platform 120 may trace the source of a network outage to facilitate immediate resolution of the issue and set up safeguards to prevent similar problems in the future.
Learn continually, to improve handling of future problems/issues/risks: AI models can also help the system learn about and adapt to changes in the environment, such as new infrastructure provisioned or reconfigured.

According to one embodiment, during operation of the data management storage solution 130, a single node called the “primary node,” which may be responsible for coordinating cluster-wide activities, may collect and report telemetry data (e.g., ASUP telemetry data 131) to the AIOps platform 120. When received from the data management storage solution 130, the AIOps platform 120 may store the telemetry data in an ASUP data lake 110 to allow the raw data to be transformed into structured data that is ready for SQL analytics, data science, and/or ML with low latency. The collection and reporting of the telemetry data by a telemetry mechanism (not shown) may be performed periodically and/or responsive to trigger events. The telemetry mechanism may proactively monitor the health of a particular data storage system or cluster and automatically send configuration, status, performance, and/or system updates to the vendor. This information may then be used by technical support personnel and/or the AIOps platform 120 to speed the diagnosis and resolution of issues (e.g., step-by-step or automated remediations). For example, when predetermined or configurable events are observed within an individual node of a given data management storage solution or at the cluster level, when manually triggered by a customer, when manually triggered by the vendor, or on a periodic basis (e.g., daily, weekly, etc.), an ASUP payload, including, among other things, information indicative of the class and type of the data management system(s) at issue, the configuration (e.g., features that are enabled/disabled) of the data management system(s) at issue, and the version of storage operating system software being run by the data management system may be generated and transmitted to the AIOps platform 120.

In one embodiment, customers of a vendor of the data management storage solution 130 may report potential issues they are experiencing with the data management storage solution 130 to technical support personnel (e.g., technical support 115) via text, chat, email, phone, or other communication channels. Information collected by technical support 115, for example, regarding a given reported issue, including, among other data, the class and type of data management system, the configuration of the data management system, and the version of storage operating system software being run by the data management system may be provided in near real-time to the AIOps platform 120.

Depending upon the particular implementation, updates (e.g., update 123) may be provided to groups of clusters based on their similarity in terms of class and/or type of data storage systems. For example, a given update may include an updated rule set (e.g., including new and/or updated rules), an updated remediation set (e.g., including new and/or updated remediations), and/or an updated ML model for use by a particular class and/or a particular type of data storage system. Alternatively, an update may be unique to a particular cluster. According to one embodiment, updates may be performed in accordance with a predefined or configurable schedule (e.g., daily, weekly, monthly, etc.) and/or responsive to manual direction from the vendor. Given a typical feature release schedule for software of a data storage system might be on the order of once or twice per calendar year, the ability to deliver such updates out-of-cycle with the release schedule provides enormous benefit. For example, customers obtain the advantages and results of enhanced risk identification and/or remediation capabilities without having to wait for the next feature release.

### Example High-Level View of a Distributed Storage System

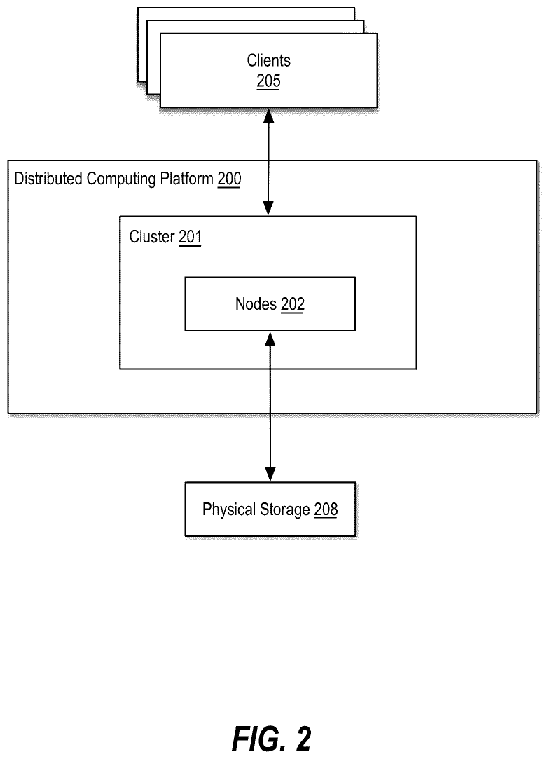

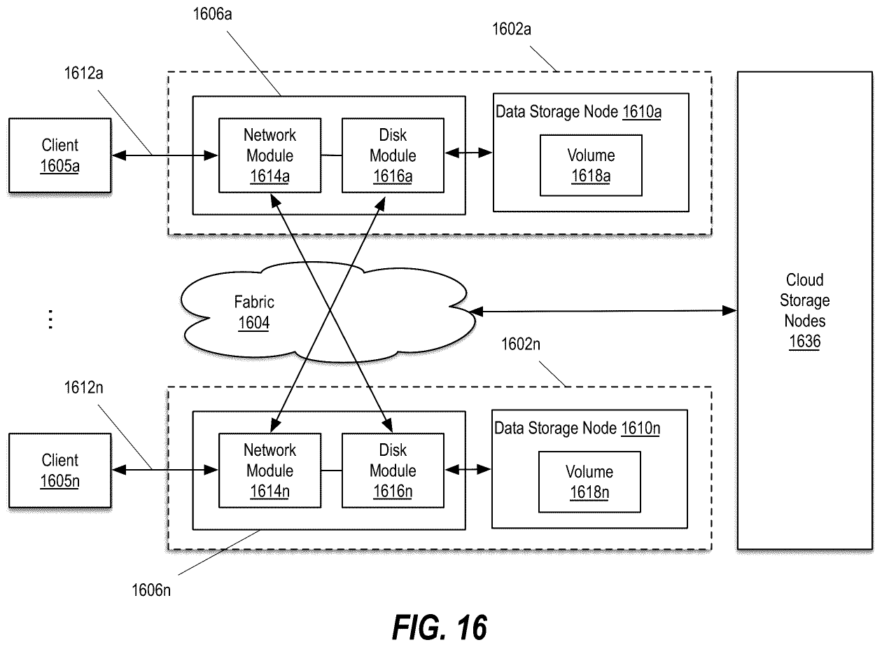

FIG. 2 is a block diagram illustrating an example of a distributed storage system (e.g., cluster 201) within a distributed computing platform 200 in accordance with one or more embodiments. In one or more embodiments, the distributed storage system may be implemented at least partially virtually. In the context of the present example, the distributed computing platform 200 includes a cluster 201, which may be analogous to data management storage solution 130. Cluster 201 includes multiple nodes 202. In one or more embodiments, nodes 202 include two or more nodes. A non-limiting example of a way in which cluster 201 of nodes 202 may be implemented is described in further detail below with reference to FIG. 16.

Nodes 202 may service read requests, write requests, or both received from one or more clients (e.g., clients 205). In one or more embodiments, one of nodes 202 may serve as a backup node for the other should the former experience a failover event. Nodes 202 are supported by physical storage 208. In one or more embodiments, at least a portion of physical storage 208 is distributed across nodes 202, which may connect with physical storage 208 via respective controllers (not shown). The controllers may be implemented using hardware, software, firmware, or a combination thereof. In one or more embodiments, the controllers are implemented in an operating system within the nodes 202. The operating system may be, for example, a storage operating system (OS) that is hosted by the distributed storage system. Physical storage 208 may be comprised of any number of physical data storage devices. For example, without limitation, physical storage 208 may include disks or arrays of disks, solid state drives (SSDs), flash memory, one or more other forms of data storage, or a combination thereof associated with respective nodes. For example, a portion of physical storage 208 may be integrated with or coupled to one or more nodes 202.

In some embodiments, nodes 202 connect with or share a common portion of physical storage 208. In other embodiments, nodes 202 do not share storage. For example, one node may read from and write to a first portion of physical storage 208, while another node may read from and write to a second portion of physical storage 208.

Should one of the nodes 202 experience a failover event, a peer high-availability (HA) node of nodes 202 can take over data services (e.g., reads, writes, etc.) for the failed node. In one or more embodiments, this takeover may include taking over a portion of physical storage 208 originally assigned to the failed node or providing data services (e.g., reads, writes) from another portion of physical storage 208, which may include a mirror or copy of the data stored in the portion of physical storage 208 assigned to the failed node. In some cases, this takeover may last only until the failed node returns to being functional, online, or otherwise available.

### Example Operating Environment

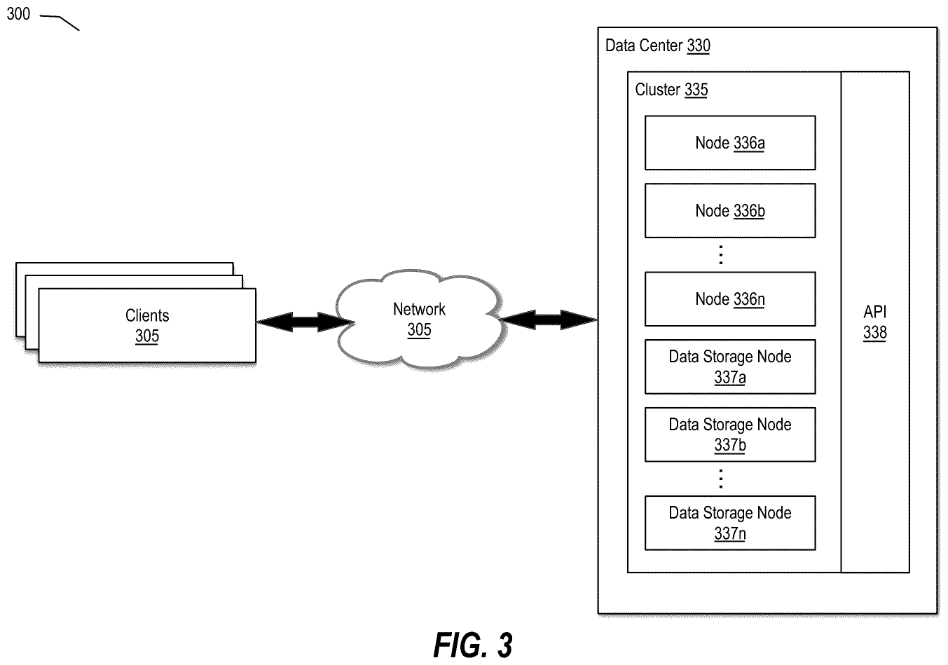

FIG. 3 is a block diagram illustrating an example on-premise environment 300 in which various embodiments may be implemented. In the context of the present example, the environment 300 includes a data center 330, a network 305, and clients 305 (which may be analogous to clients 205). The data center 330 and the clients 305 may be coupled in communication via the network 305, which, depending upon the particular implementation, may be a Local Area Network (LAN), a Wide Area Network (WAN), or the Internet. Alternatively, some portion of clients 305 may be present within the data center 330.

The data center 330 may represent an enterprise data center (e.g., an on-premises customer data center) that is built, owned, and operated by a company or the data center 330 may be managed by a third party (or a managed service provider) on behalf of the company, which may lease the equipment and infrastructure. Alternatively, the data center 330 may represent a colocation data center in which a company rents space of a facility owned by others and located off the company premises. The data center 330 is shown including a distributed storage system (e.g., cluster 335). Those of ordinary skill in the art will appreciate additional information technology (IT) infrastructure would typically be part of the data center 330; however, discussion of such additional IT infrastructure is unnecessary to the understanding of the various embodiments described herein.

Turning now to the cluster 335 (which may be analogous to data management storage solution 130 and/or cluster 201), it includes multiple nodes 336a-n and data storage nodes 337a-n (which may be analogous to nodes 202 and which may be collectively referred to simply as nodes) and an Application Programming Interface (API) 338. In the context of the present example, the nodes are organized as a cluster and provide a distributed storage architecture to service storage requests issued by one or more clients (e.g., clients 305) of the cluster. The data served by the nodes may be distributed across multiple storage units embodied as persistent storage devices, including but not limited to hard disk drives, solid state drives, flash memory systems, or other storage devices. A non-limiting example of a node is described in further detail below with reference to FIG. 16.

The API 338 may provide an interface through which the cluster 335 is configured and/or queried by external actors. Depending upon the particular implementation, the API 338 may represent a Representational State Transfer (REST)ful API that uses Hypertext Transfer Protocol (HTTP) methods (e.g., GET, POST, PATCH, DELETE, and OPTIONS) to indicate its actions. Depending upon the particular embodiment, the API 338 may provide access to various telemetry data (e.g., performance, configuration and other system data) relating to the cluster 335 or components thereof. As those skilled in the art will appreciate various types of telemetry data may be made available via the API 337, including, but not limited to measures of latency, utilization, and/or performance at various levels (e.g., the cluster level, the node level, or the node component level). The telemetry data available via API 337 may be include ASUP telemetry data (ASUP telemetry data 131) or the ASUP telemetry data may be provided to an AIOps platform (e.g., AIOps platform 120) separately.

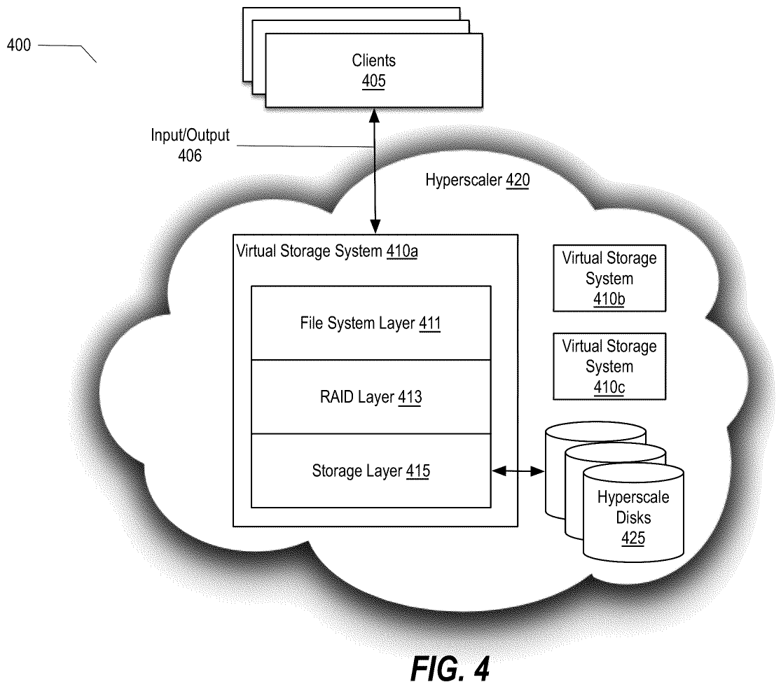

FIG. 4 is a block diagram illustrating an example cloud environment (e.g., hyperscaler 420) in which various embodiments may be implemented. In the context of the present example, a virtual storage system 410a, which may be considered exemplary of virtual storage systems 410b-c, may be run (e.g., within a VM or in the form of one or more containerized instances, as the case may be) within a public cloud provided by a public cloud provider (e.g., hyperscaler 420). Collectively, a cluster including one or more of virtual storage systems 410a-c may be analogous to data management storage solution 130 of FIG. 1.

In this example, the virtual storage system 410a makes use of storage (e.g., hyperscale disks 425) provided by the hyperscaler, for example, in the form of solid-state drive (SSD) backed or hard-disk drive (HDD) backed disks. The cloud disks (which may also be referred to herein as cloud volumes, storage devices, or simply volumes or storage) may include persistent storage (e.g., disks) and/or ephemeral storage (e.g., disks), which may be analogous to physical storage 208.

The virtual storage system 410a (which may be analogous to a node of data management storage solution 130, one of nodes 202, and/or one of nodes 336a-n) may present storage over a network to clients 405 (which may be analogous to clients 205 and 305) using various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 405 may request services of the virtual storage system 410 by issuing Input/Output requests 406 (e.g., file system protocol messages (in the form of packets) over the network). A representative client of clients 405 may comprise an application, such as a database application, executing on a computer that “connects” to the virtual storage system 410 over a computer network, such as a point-to-point link, a shared local area network (LAN), a wide area network (WAN), or a virtual private network (VPN) implemented over a public network, such as the Internet.

In the context of the present example, the virtual storage system 410a is shown including a number of layers, including a file system layer 411 and one or more intermediate storage layers (e.g., a RAID layer 413 and a storage layer 415). These layers may represent components of data management software or storage operating system (not shown) of the virtual storage system 410. The file system layer 411 generally defines the basic interfaces and data structures in support of file system operations (e.g., initialization, mounting, unmounting, creating files, creating directories, opening files, writing to files, and reading from files). A non-limiting example of the file system layer 411 is the Write Anywhere File Layout (WAFL) Copy-on-Write file system (which represents a component or layer of ONTAP software available from NetApp, Inc. of San Jose, CA).

The RAID layer 413 may be responsible for encapsulating data storage virtualization technology for combining multiple hyperscale disks 425 into RAID groups, for example, for purposes of data redundancy, performance improvement, or both. The storage layer 415 may include storage drivers for interacting with the various types of hyperscale disks 425 supported by the hyperscaler 420. Depending upon the particular implementation the file system layer 411 may persist data to the hyperscale disks 425 using one or both of the RAID layer 413 and the storage layer 415.

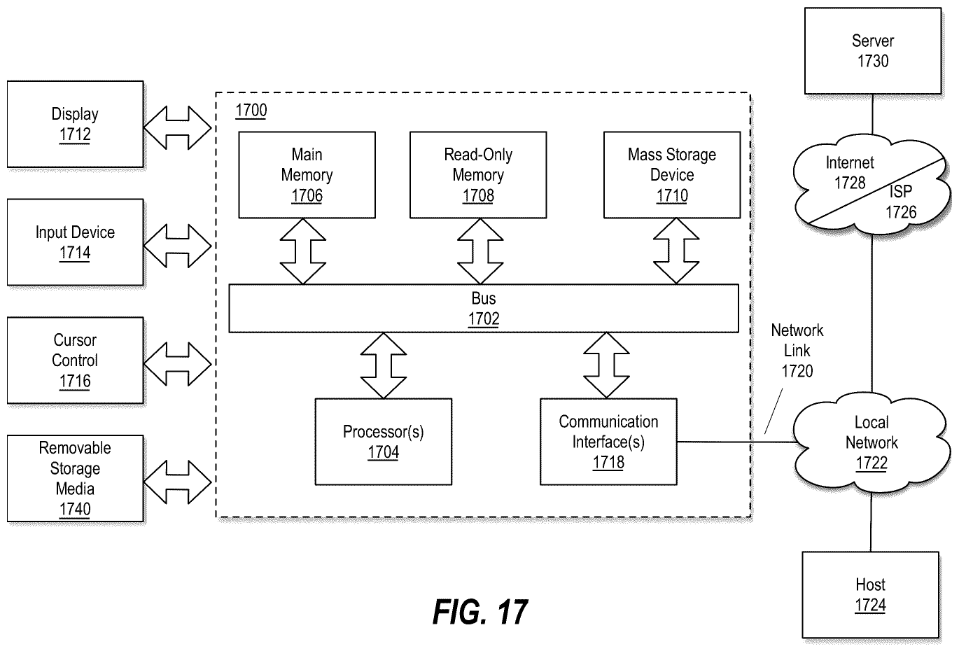

The various layers described herein, and the processing described below may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms (e.g., servers, blades, network storage systems or appliances, and storage arrays, such as the computer system described with reference to FIG. 17 below.

### Example System Manager Dashboard Screenshots

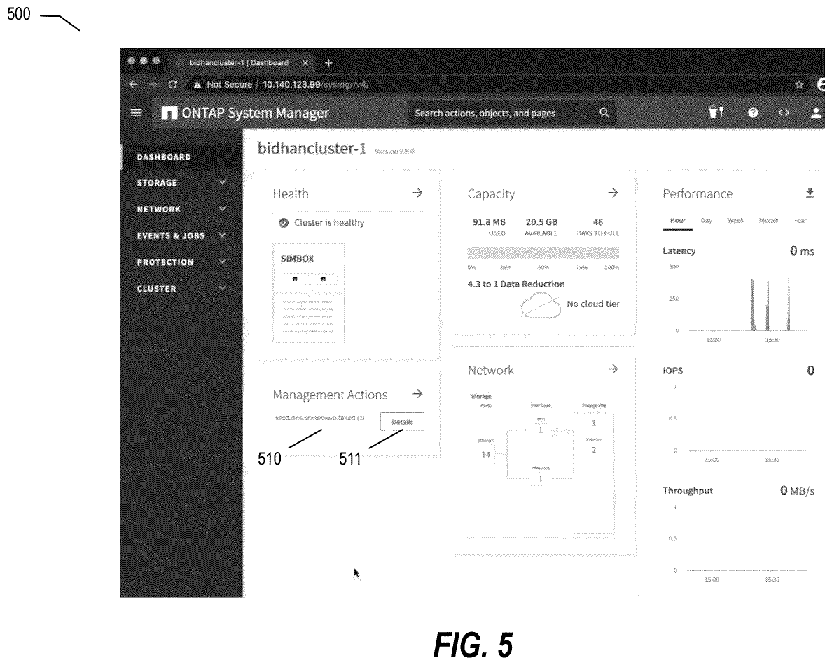

FIG. 5 illustrates an example screen shot 500 of a system manager dashboard in accordance with one or more embodiments. In the context of various examples described herein the system manager dashboard may be part of a graphical user interface of a management platform that facilitates setup and/or deployment of a distributed storage system (e.g., data management storage solution 130, cluster 201, cluster 335, or a cluster involving one or more of virtual storage systems 410a-c) or data storage system thereof. In the context of the present example, a DNS lookup failure event has occurred as indicated by 510. An administrative user may view details associated with this event by selecting the “Details” button 511.

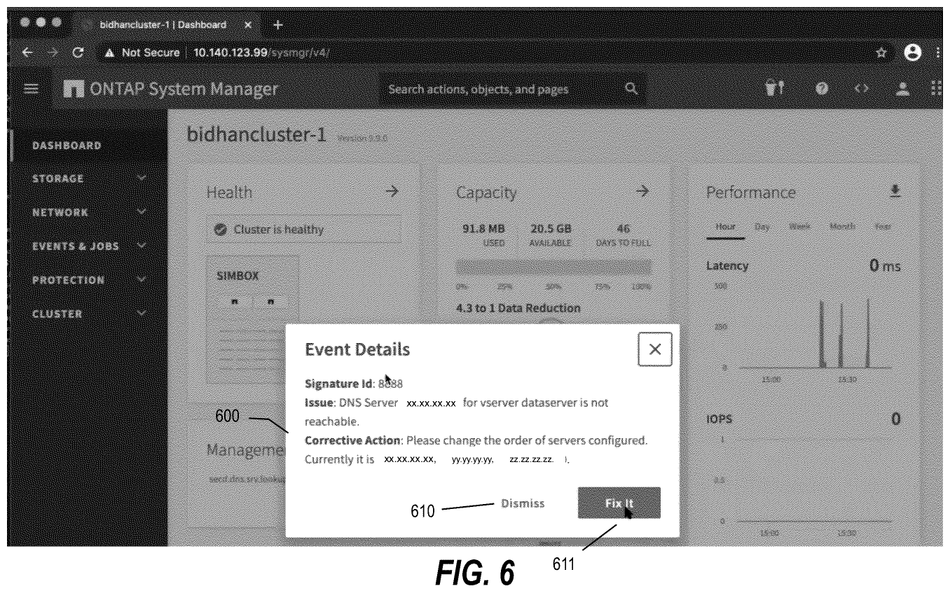

FIG. 6 illustrates an example dialog box 600 that may be presented by the system manager dashboard responsive to selection of the details button from the screen shot of FIG. 5 in accordance with one or more embodiments. In the context of the present example, the dialog box 600 provides event details for the DNS lookup failure event, including a signature ID, information regarding the issue, and corrective action. The dialog box 600 provides the administrative user with the option of dismissing the event (e.g., by selecting the “Dismiss” button 610) or allowing the auto-healing service to perform a remediation (e.g., by selecting the “Fix It” button 611).

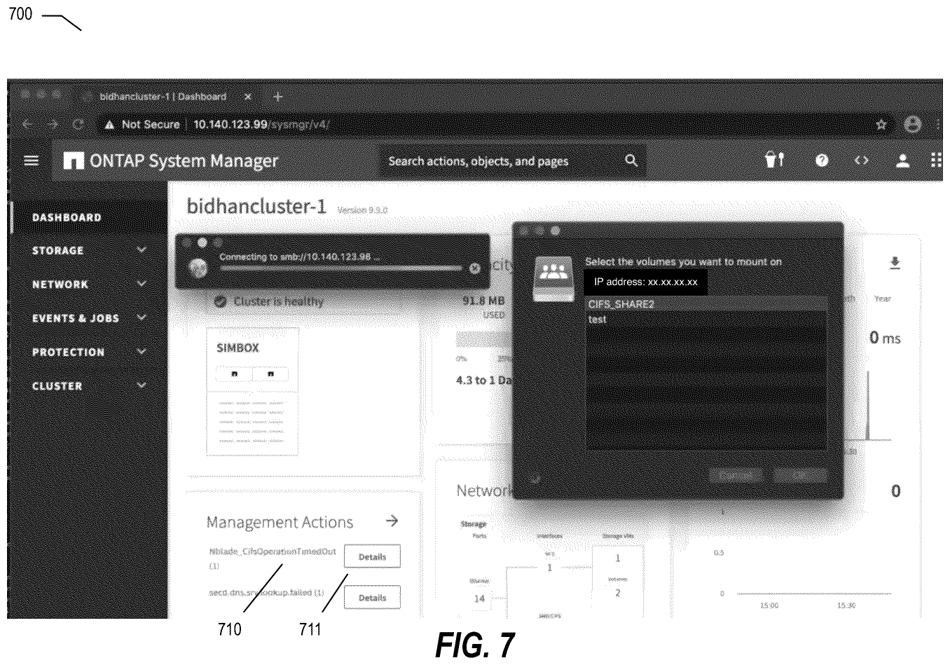

FIG. 7 illustrates another example screen shot 700 of a system manager dashboard in accordance with one or more embodiments. In the context of the present example, a CIFS share offline event has occurred as indicated by 710. An administrative user may view details associated with this event by selecting the “Details” button 711.

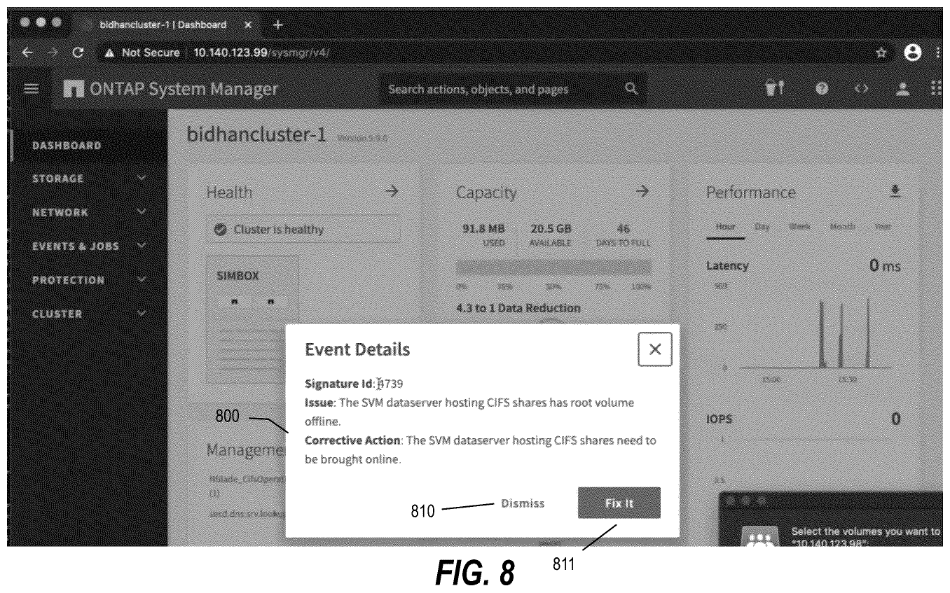

FIG. 8 illustrates an example dialog box 800 that may be presented by the system manager dashboard responsive to selection of the details button from the screen shot of FIG. 7 in accordance with one or more embodiments. In the context of the present example, the dialog box 800 provides event details for the CIFS share offline event, including a signature ID, information regarding the issue, and corrective action. The dialog box 800 provides the administrative user with the option of dismissing the event (e.g., by selecting the “Dismiss” button 810) or allowing the auto-healing service to perform a remediation (e.g., by selecting the “Fix It” button 811).

While for purposes of explanation, two specific examples of NAS events and corresponding remediations have been described above with reference to FIGS. 5-8, it is to be appreciated the methodologies described herein are broadly applicable to other types of events (e.g., SAN events, security issues, performance issues, capacity issues, and/or compliance issues). For instance, consider a capacity example in which a storage capacity forecast may be run responsive to an EMS event indicative of a volume being X % (e.g., 80%) full. An associated rule may be run responsive to the EMS event to forecast when the volume will be at Y % (e.g., 100%) full. If the forecasted fullness date is within N (e.g., 3) months, a remediation may be generated. When the remediation is dispatched, the volume size may be increased by M % (e.g., 20%). Similarly, consider a security example in which a deduplication/reduction decrease may be evaluated. An EMS event may be received that is indicative of the deduplication/reduction percentage on a given aggregate has decrease by more than X % (e.g., 5%). In this case, an associated rule may be triggered to run to determine the source volume of the deduplication/reduction decrease. The volume behavior may be compared with historical and forecasted values. If the volume is found to be suspect, a remediation may be created. The rule may also determine whether the last snapshot that was taken before the suspect behavior. When the remediation is dispatched the administrator may be asked to validate if the suspect volume has been compromised, if so the administrator may be given the option to roll the volume back to prescribed snapshot.

### Example Auto-Healing Service

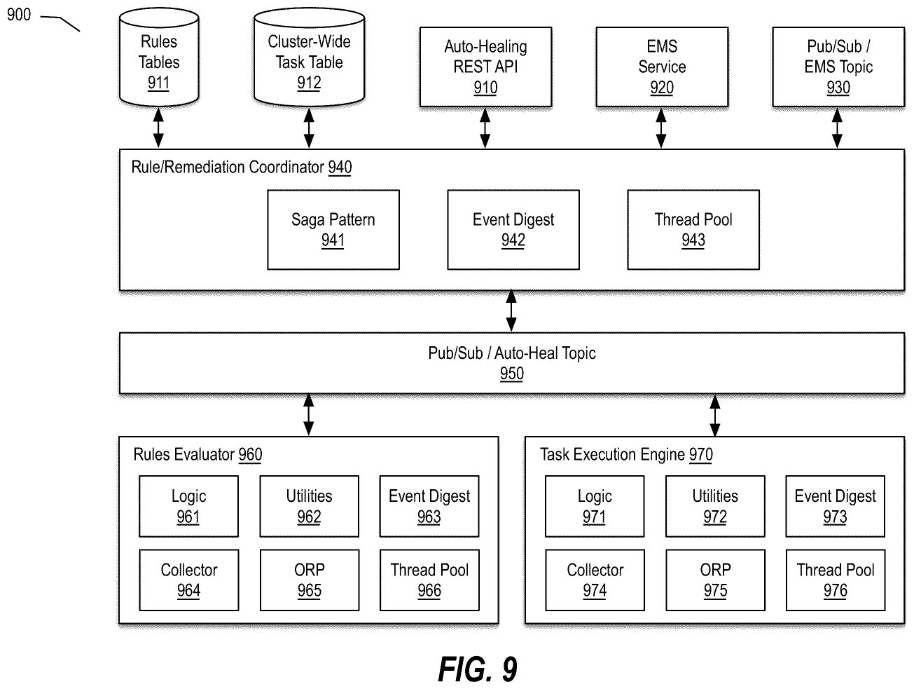

FIG. 9 is a block diagram illustrating components of an auto-healing service 900 that may be implemented within a node (e.g., node 202, 336a-n, or one of virtual storage systems 410a-c) of a cluster (e.g., cluster 201, cluster 335, or a cluster of one or more of virtual storage systems 410a-c), for example, representing a data management storage solution (e.g., data management storage solution 130) in accordance with one or more embodiments. Auto-healing is a breakthrough feature that can help resolve many of the pain points of administrative users, for example, by way of offering a “Fix It” button as discussed above with reference to FIGS. 5-8.

In the context of the present example, the major components that make up the auto-healing service 900 include, a rule/remediation coordinator 940, a cluster-wide task table 912, an auto-healing REST API 910, an event management system (EMS) service 920, a publisher/subscriber (pub/sub)/EMS topic 930, a rules table 911, a pub/sub/auto-heal topic 950, a rules evaluator 960, and a task execution engine 970.

The rule/remediation coordinator 940 may be responsible for coordinating the execution of rules and remediations for the cluster. In one embodiment the auto-healing service 900 runs on a single node called the “primary node” that can coordinate cluster-wide activities.

According to one embodiment, the rule/remediation coordinator 940 oversees the detection and scheduling of rules and remediations. The rule/remediation coordinator 940 may use a distributed Saga design pattern (e.g., Saga pattern 941) for managing failures and recovery, where each action has a compensating action for roll-back/roll-forward.

For example, the distributed Saga design pattern may be used as a mechanism to manage data consistency across multiple services (e.g., microservices) in distributed transaction scenarios. A saga is a sequence of transactions that updates each service and publishes a message or event to trigger the next transaction step. If a step fails, the saga executes compensating transactions that counteract the preceding transactions.

While in the context of the present example, the auto-healing service 900 is described as running on a single node within the cluster, it is to be appreciated if a node running the auto-healing service 900 fails, another node of the cluster may be elected to run the auto-healing service 900.

The cluster-wide task table 912 may be responsible for logging the steps of a given rule execution and/or a given remediation execution. In the case of a failure of the rule/remediation coordinator 940, the cluster-wide task table 912 may be used to restart execution of running rules/remediations from the point at which they were interrupted by the failure.

The auto-healing REST API 910 provides an interface through which requests for remediation execution may be received from an administrative user of the cluster, for example, as a result of interactions of a user interface presented by a system manager dashboard.

The EMS service 920 may represent an event system that includes monitoring and create, read, update, and delete (CRU)-based alerting. The EMS service 920 may collect and log event data from different parts of the storage operating system kernel and provide event forwarding mechanisms to allow the events to be reported as EMS events. For example the EMS service 920 may be used to create and modify EMS messages (with stateful attributes).

In one embodiment, a pub/sub bus (including, for example, pub/sub/EMS topic 930 and pub/sub/auto-heal topic 950) is provided to facilitate the exchange of messages among components of the auto-healing service 900. In one embodiment, a topic may be specified by the source component when itad publishes a message and subscribers may specify the topic(s) (e.g., pub/sub/EMS topic 930 and/or pub/sub/auto-heal topic 950) for which they want to receive publications.

The pub/sub/EMS topic 930 may be used to listen for (e.g., register to be notified regarding) key EMS messages (e.g., those to which the rule/remediation coordinator is subscribed) and used to trigger execution of rule(s) and/or remediations by the rules evaluator 960 and the task execution engine 970, respectively.

The rules table 911 may be used to store and retrieve information about the mapping between EMS events and associated rules to be executed as well as information regarding scheduled risk checks.

The pub/sub/auto-heal topic 950 may be used for communication between the rule/remediation coordinator 940 and the rules evaluator 960 and between the rule/remediation coordinator 940 and the task execution engine 970.

The rules evaluator 960 may be responsible for overseeing the execution of rules and the detection of risks. Depending on the needs of the particular deployment, the auto-healing service 900 may be scaled by running multiple instances of the rules evaluator 960 on other nodes of the cluster. The rules evaluator 960 may build the dependency of rules to triage and rules to run to remediate. The rules evaluator 960 may perform triaging using the triage rules and may dispatch remediation based input for remediation executions.

In the context of the present example, the rules evaluator 940 is shown including a logic controller 961, utilities 962, a collector module 964, an open rule platform (ORP) 965, an event digest module 963, and a thread pool 966. The logic controller 961 may be responsible for taking care of the rules evaluator logic. For example, the rules evaluator 960 may be responsible for binding the rules to be run. The logic controller 961 may take care of mapping rules to collectors and parsers (not shown) as well as executing the rules using the ORP 965. Additionally, the logic controller 961 may be responsible for getting the required sections collected using the collector 964. In one embodiment, the logic controller 961 may use the thread pool 966 to execute the rules evaluator logic. The logic controller 961 may also handle error and exception handling. The logic controller 961 may utilize the event digest 963 to communicate with the pub/sub bus.

The utilities 962 may represent helper functions needed for the functioning of the rules evaluator 960. In one embodiment, the utilities 962 may be shared across the rules evaluator 960 and the task execution engine 970.

In one embodiment, the collector module 964 represents a wrapper class for running collection needs, including collecting information from various services within the storage cluster. For example, data may be retrieved from an SMF database (e.g., an SQL collector) by using the DOT SQL package to run collection from the SMF database. The collector module 964 may use the thread pool 966 for asynchronous functionality of the collector 964. The collector 964 may be generic, for example, by accepting instructions, executing the instructions, and returning values.

The ORP 965 may provide the rules that are executed along with the infrastructure to execute the rules. The ORP 965 may be updated with the latest rules on a periodic basis or on demand from the vendor. For example, an update (e.g., update 123) received by the data management storage from an AIOps service (e.g., AIOps 120) may include a new rule set containing updated rules and/or additional rules or a new ML model to be used by the auto-healing service 900 to determine the existence of a risk to which the data management storage solution is exposed.

This event digest module 963 may be a generic module used to communicate. In one embodiment, the event digest module 963 is used to register and communicate to the pub/sub bus. For example, the event digest module 963 may include functions to subscribe or publish to auto-heal topics via pub/sub auto-heal topic 950.

In the context of the present example, the thread pool 966 generally represents a collection of polymorphic threads, which allows it to be shared across functions.

The task execution engine 970 may be responsible for overseeing the execution of remediations and other tasks that may be distributed across the cluster. Depending on the needs of the particular deployment, the auto-healing service 900 may be scaled by running multiple instances of the task execution engine 970 on one or more other nodes of the cluster.

In the context of the present example, the task execution engine 970 is also shown including a logic controller 971, utilities, a collector module 974, an open rule platform (ORP) 975, an event digest module 973, and a thread pool 976.

The logic controller 971 may handle the remediation logic. For example, the logic controller 971 may be responsible for mapping rules to collectors and parsers. The logic controller 971 may also take care of executing remediation actions (e.g., issuing storage commands, using an ML model to make predictions, and/or executing a remediation script), including getting the required inputs. The logic controller 971 may use the thread pool 976 to execute the remediation logic. Additionally, the logic controller 971 may take care of error and exception handling. The logic controller 971 may make use of the event digest module 973 to communicate back to the pub/sub bus.

As noted above, the utilities 972 may represent helper functions needed for the functioning of the rules evaluator 960 and/or the task execution module 970. In one embodiment, the utilities 972 may be shared between the rules evaluator 960 and the task execution module 970.

In one embodiment, the collector module 974 represents a wrapper class for running collection needs, including collecting information from various services within the storage cluster. For example, data may be retrieved from an SMF database (e.g., an SQL collector) by using the DOT SQL package to run collection from the SMF database. The collector module 974 may use the thread pool for asynchronous functionality of the collector 974. The collector 974 may be generic, for example, by accepting instructions, executing the instructions, and returning values.

The ORP 975 may provide the rules that are executed along with the infrastructure to execute the rules. The ORP 975 may be updated with the latest remediations on a periodic basis or on demand from the vendor. For example, an update (e.g., update 123) received by the data management storage solution from an AIOps service (e.g., AIOps 120) may include a new remediation set containing updated remediations and/or additional remediations to be used by the auto-healing service 900 to mitigate or address risks detected by the rules evaluator 960 automatically or responsive to receipt of manual approval by an administrative user.

This event digest module 973 may be a generic module used to communicate. In one embodiment, the event digest module 973 is used to register and communicate to the pub/sub bus. For example, the event digest module 973 may include functions to subscribe or publish to auto-heal topics via pub/sub auto-heal topic 950.

In the context of the present example, the thread pool 976 generally represents a collection of polymorphic threads, which allows it to be shared across functions.

Returning to the rule/remediation coordinator 940, it may be responsible for overseeing one or more of the following activities:
Subscribing to key EMS events (e.g., via the pub/sub/EMS topic 930). When an event is detected, the rule/remediation coordinator 940 may route a request to the rules evaluator 960 for the associated rule.
Logging the various actions of the rule and remediation execution within the cluster-wide task table 912 to facilitate recovery in the case of a failure of the rule/remediation coordinator 940, the rule evaluator 960, and/or the task execution engine 970.
Receipt of requests for remediation execution. In one embodiment, requests for remediation may arrive via one of two sources. When remediation for a given risk is to be manually approved by an administrative user, the request for execution of the remediation may be received via the auto-healing REST API 910, for example, responsive to the administrative user authorizing the remediation via a user interface presented by a system manager dashboard. Alternatively, when a given risk is set to fully automated, the risk may be routed to the rule/remediation coordinator 940 via the pub/sub/auto-heal topic 950. The rule/remediation coordinator 940 may determine whether the remediation is to be automatically executed. If so, the rule/remediation coordinator 940 may route a remediation request to the task execution engine 970.
When a stateful EMS event needs to be updated, the rule/remediation coordinator 940 may handle such operations.
Maintaining of a mapping within the rules tables 911 between EMS events and associated rules to be executed.
The rule/remediation coordinator 940, rule evaluator 960, and task execution engine 970 may communicate via the pub/sub/auto-heal topic 950. In one embodiment, requests may be routed by rule/remediation coordinator 940 the to the rule evaluator 960 or task execution engine 970 on any of the nodes within the cluster for execution. Responses may be routed to the current primary rule/remediation coordinator 940.
Failure recovery:
   In the case of a failure of the rule/remediation coordinator 940, the primary coordinator role can be taken over by another node. In this case, the cluster-wide task table 912 may be used to resume the activities that were in progress at the time of the failure.
   A timeout mechanism may be used when a request is sent to the rule evaluator 960 or task execution engine 970 to detect a failure of the rule evaluator 960 or the task execution engine 970. If a request times out, the rule/remediation coordinator 940 may be responsible for roll-back or roll-forward for the given activities. Because a given rule or remediation can be called repeatedly in some error conditions, the given rule or remediation should be idempotent (i.e., a given method will produce the same result when called repeatedly).
   Each step of the risk and remediation may be check pointed (e.g., following the Saga pattern). Such checkpoints facilitate failure recovery. For example, if a coordinator 940 crashes, upon restarting it can look at outstanding operations. If the rules evaluator 960 or task execution engine 970 crashes. Any outstanding request will timeout with the rule/remediation coordinator 940 and the command may be re-sent.
Missing rules:
   Rule pre-checks may be performed to determine if all resources are available to run rules. If there is a corruption or missing rules, an error may be raised and the corruption or missing rules may be addressed or restored as appropriate.
Remediation Missing for an Event:
   Remediation pre-checks may be performed to check for the existence of a remediation action or script before firing the remediation. If there is a corruption or missing script, an error may be raised.
Status Updates and Timeout:
   The rules evaluator 960 and the task executer 970 may communicate back to the rule/remediation coordinator 940 with periodic status updates to provide granular updates. Timeouts may be set for the rules evaluator(s) 940 and/or the task executor(s) 970, so as to ensure there are no hung threads. These timeouts may be overridden in a situation in which there is an obvious long-running thread.
Idempotency:
   For Rules:
      When a new risk is identified, a check may be performed to see if the alert is currently active for the risk. If so, the new risk may be ignored so as to avoid duplication.
      When a new risk is identified, a check may be performed to see if an alert for the risk was recently dismissed. If so, the alert may be suppressed. The duration for such suppression may be specified in the rule. A recent dismissal of a given risk, for example, within the last X minutes or Y hours may also be used as part of auto-remediation logic as a factor in determining whether the given risk should be automatically remediated or whether the given risk should be remediated after receiving manual approval.
   For Remediations:
      When a remediation action or script is executed to implement a remediation, a check may first be performed to ensure the alert is still valid. If the risk is no longer valid, the alert may be placed into a terminal state.

### Example Organization and Relationship Between Rules and Remediations

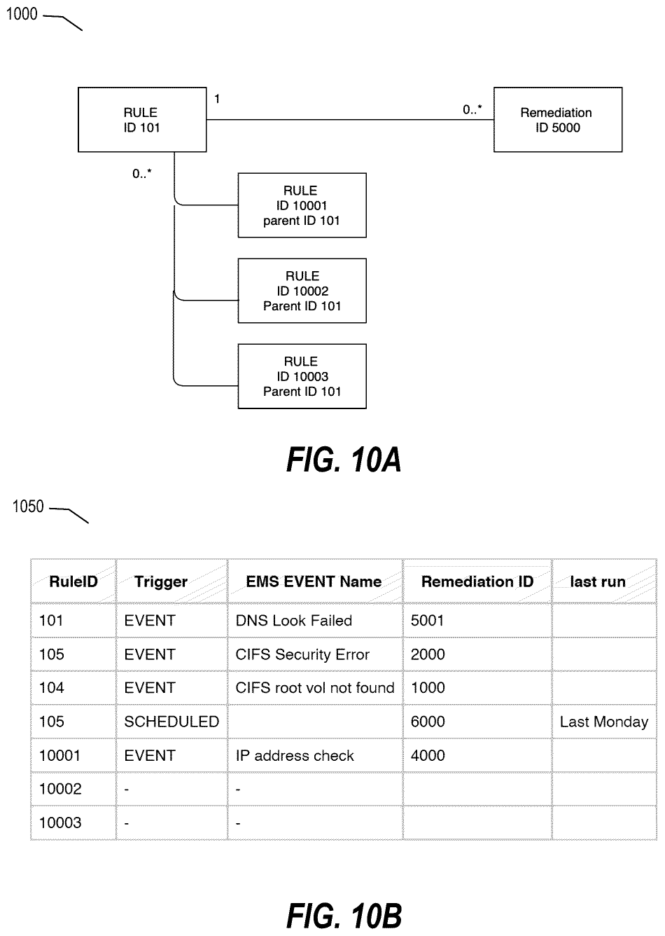

FIG. 10A is an entity relationship diagram 1000 for rules and remediations in accordance with one or more embodiments. In one embodiment, a given rule identifier (ID) may be associated with zero or more remediation IDs and a given rule ID may have zero or more child rules IDs.

FIG. 10B is an example of a rules table 1050 in accordance with one or more embodiments. The rules table 1050 may be analogous to the rules tables 911 used by the auto-healing service 900 of FIG. 9. In the context of the present example, each rule ID has an associated trigger (e.g., event or scheduled), an associated EMS event name, an associated remediation ID, and a last run indicator (e.g., a timestamp indicating the time/date of the last time the rule was run). In this manner, key EMS events may be used to trigger a deep analysis (e.g., of some corresponding set of one or more rules) via a rules engine (e.g., rules evaluator 960) and other rules may be run on a periodic schedule.

As those skilled in the art will appreciate, it may be preferable to perform event-based triggering when available as they may provide reduced overhead and complexity; however, some types of checks (e.g., best practices and performance checks) lend themselves well to scheduling. For example, if an administrative user wants to check whether a given cluster is complying with SAN best practices (e.g., as defined by the vendor), the administrator may schedule one or more rules associated with SAN best practices to run periodically (e.g., once a month). Similarly, the administrator may schedule one or more rules associated with security and/or performance checks to be performed on a periodic basis.

In one embodiment, a given rule may contain the ID(s) of the trigger events (e.g., the EMS event(s)) it is looking for. The trigger event ID information can be inferred by scanning all the active rules or by a catalog that is maintained. A coordinator (e.g., rule/remediation coordinator 940) may register with a pub/sub bus (e.g., pub/sub/EMS topic 930) for the event IDs of interest. In this manner, an auto-healing service (e.g., auto-healing service 900) may avoid listening to all events.

### Example Automated Remediation

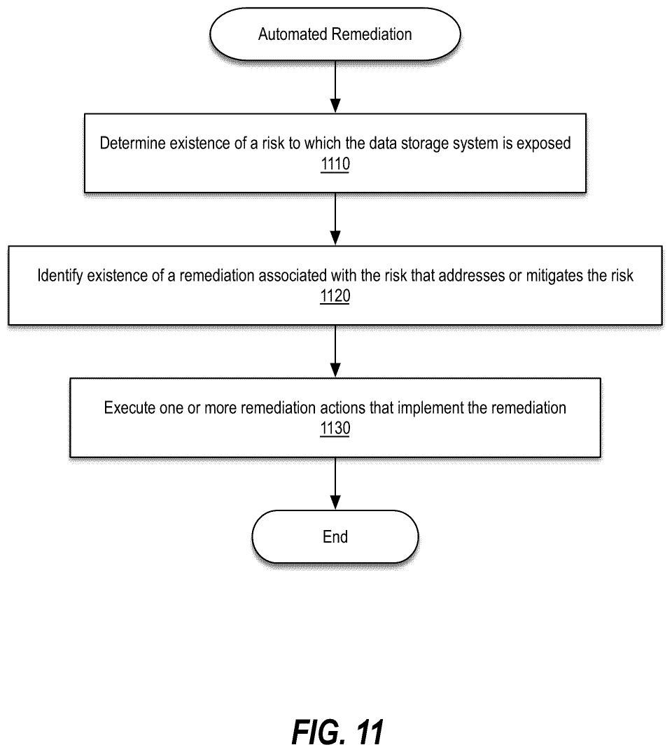

FIG. 11 is a flow diagram illustrating a set of operations for performing automated remediation in accordance with one or more embodiments. The processing described with reference to FIG. 11 may be performed by an auto-healing service (e.g., auto-healing service 900) running within a distributed storage system (e.g., data management storage solution 130, cluster 201, cluster 335, or a cluster of one or more virtual storage systems 410a-c). In the context of the present example, it is assumed a rule evaluation has been triggered, for example, as a result of the occurrence of a key EMS event or as a result of a schedule associated with a particular rule.

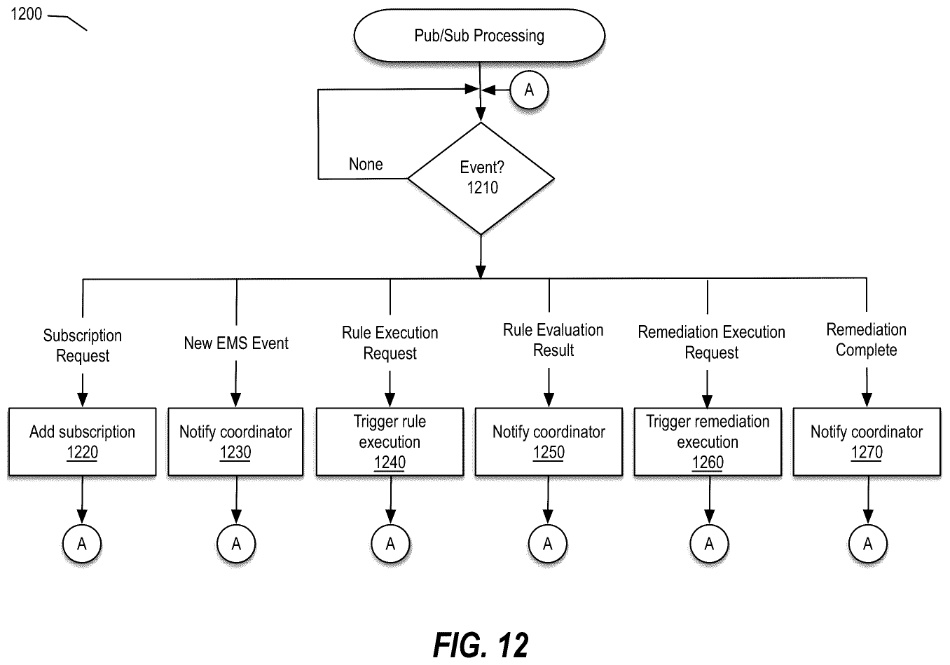

At block 1110, the existence of a risk to which the data storage system is exposed is determined. The risk might represent a misconfiguration of the data storage system, an environmental issue (e.g., a DNS change or network reconfiguration) that might impact the data storage system, a security issue relating to the data storage system, a performance issue relating to the data storage system, or a capacity issue relating to the data storage system. The exposure to a particular risk may be determined by evaluating one or more conditions associated with a set of one or more rules that are indicative of a root cause of the risk. The one or more rules may be associated with a trigger event (e.g., the occurrence of a key EMS event or a predetermined or configurable schedule). According to one embodiment, a rules evaluator (e.g., rules evaluator 960) may be directed (e.g., via a pub/sub pattern) to evaluate (execute) a set of one or more rules (e.g., organized hierarchically with a parent rule at the root and zero or more child rules) by a coordinator (e.g., rule/remediation coordinator 940). Non-limiting examples of pub/sub processing, coordinator processing, and rule execution are described further below with reference to FIGS. 12, 13, and 14, respectively.

At block 1120, a remediation associated with the risk determined in block 1110 is identified that addresses or mitigates the risk. According to one embodiment, a given rule (e.g., a parent rule) may include information regarding or a reference to a remediation, for example, a remediation ID that may be used to look up the remediation action(s) or remediation script within a remediation table. Assuming the existence of an associated remediation, a task execution engine (e.g., task execution engine 970) may be directed (e.g., via a pub/sub pattern) to carry out (implement) a set of one or more remediation actions or a remediation script by the coordinator.

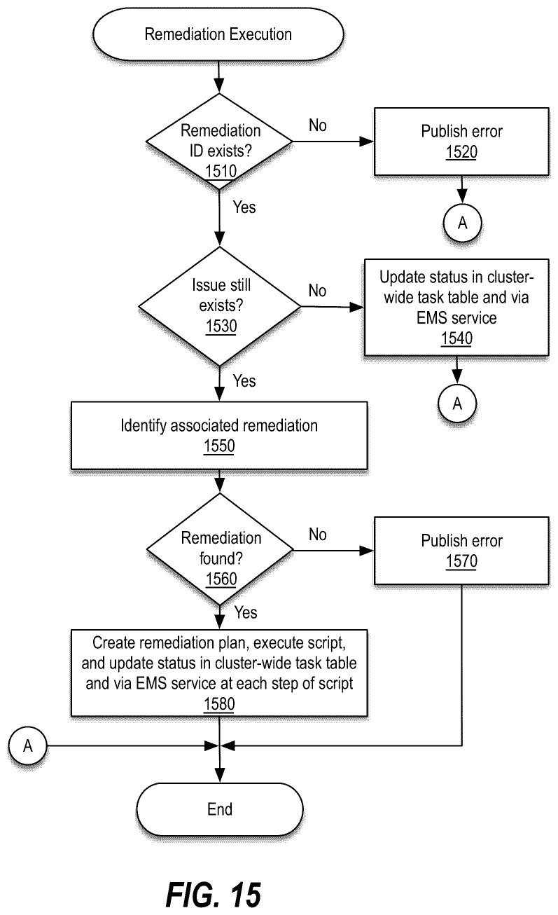

At block 1130, the set of one or more remediation actions are executed. For example, responsive to receipt of a remediation execution request via a pub/sub bus (e.g., pub/sub/auto-heal topic 950) the task execution engine may execute the set of one or more remediation actions to implement the remediation identified in block 1120. A non-limiting example of remediation execution is described further below with reference to FIG. 15.

### Example Pub/Sub Processing

FIG. 12 is a flow diagram illustrating as set of operations for performing pub/sub processing in accordance with one or more embodiments. The processing described with reference to FIG. 12 may represent an example of the handling of messages published to a pub/sub bus.

At decision block 1210, an event indicative of a type of message published to the pub/sub bus is determined. When no message has been published, processing loops back to decision block 1210.

Responsive to a subscription request, processing continues with block 1220 at which the requester is added as a subscriber to a topic specified by the subscription request.

Responsive to a new EMS event, processing continues with block 1230 to notify a coordinator (e.g., the rule/remediation coordinator 940 of FIG. 9) of the new EMS event.

Responsive to a rule execution request message published (e.g., to the pub/sub/auto-heal topic 950 of FIG. 9) by the coordinator, processing continues with block 1240 to trigger rule execution by a rule evaluator (e.g., the rule evaluator 960 of FIG. 9).

Responsive to a rule evaluation result message published (e.g., to the pub/sub/auto-heal topic 950 of FIG. 9) by the rule evaluator, processing continues with block 1250 to notify the coordinator.

Responsive to a remediation execution request message published (e.g., to the pub/sub/auto-heal topic 950 of FIG. 9) by the coordinator, processing continues with block 1260 to trigger remediation execution by a task execution engine (e.g., the task execution engine 970 of FIG. 9). Responsive to a remediation complete message published (e.g., to the pub/sub/auto-heal topic 950 of FIG. 9) by the task execution engine, processing continues with block 1270 to notify the coordinator.

### Example Rule/Remediation Execution Coordination

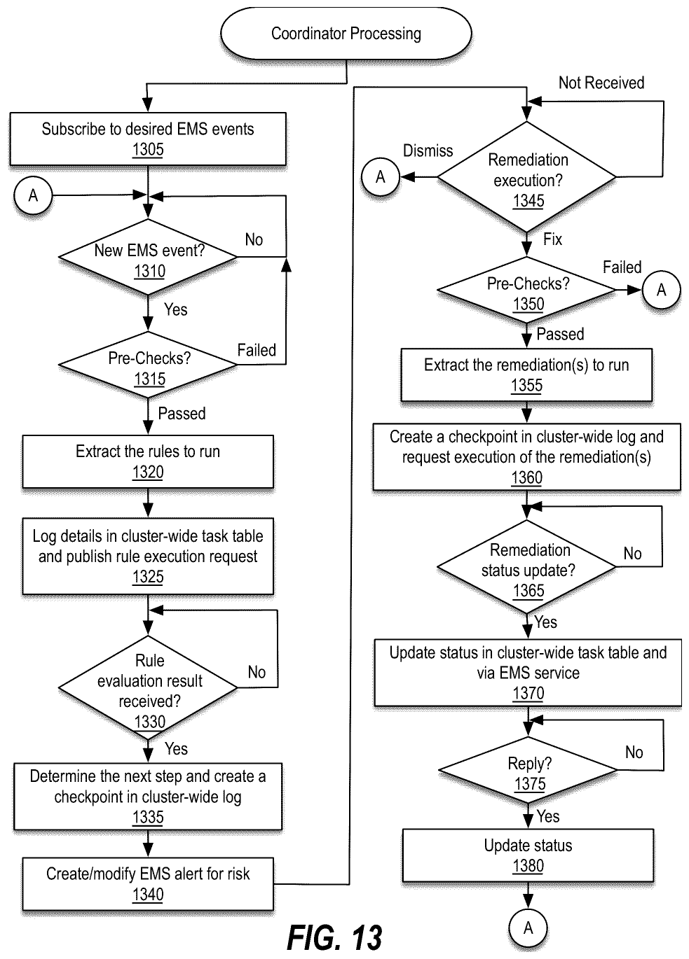

FIG. 13 is a flow diagram illustrating as set of operations for coordinating execution of rules and remediations in accordance with one or more embodiments. The processing described with reference to FIG. 13 may represent an example of processing performed by a coordinator (e.g., the rule/remediation coordinator 940 of FIG. 9).

At block 1305, the coordinator may upon initialization subscribe to desired EMS events. For example, the coordinator may post a subscription request message specifying the pub/sub EMS topic so as to be automatically notified by the pub/sub bus of subsequent messages posted to this topic.

At decision block 1310, it is determined whether a new EMS event has been received. If so, processing continues with decision block 1315; otherwise processing loops back to decision block 1310.

At decision block 1315, one or more rule execution pre-checks may be performed. If all pre-checks pass, processing continues with block 1320; otherwise, processing loops back to decision block 1310 to await receipt of another EMS event. In one embodiment, the one or more rule pre-checks may include performing a check regarding whether a mapping exists for the event ID of the EMS event at issue to a corresponding rule ID of a rule to be executed. If no mapping is found, the pre-checks may be treated as having failed. Alternatively, or additionally the one or more rule pre-checks may include performing a check to determine whether an entry exists in a task table (e.g., the cluster-wide task table 912 of FIG. 9) for the EMS event at issue. If so, triaging is already in process for this EMS event and the pre-checks may be treated as having failed.

At block 1320, the rule(s) to be run are extracted. For example, the coordinator may determine the rule ID to which the event ID of the EMS event at issue maps.

At block 1325, details (e.g., the rule ID and the event ID) may be logged in the task table and a rule execution request message (including the rule ID and optionally the node ID to which the rule execution is being delegated if the rule execution is not to be performed by the primary node) may be posted/published to a pub/sub topic (e.g., a pub/sub “evaluate” topic) to trigger execution of the rules associated with the rule ID by a rules evaluator (e.g., the rules evaluator 960 of FIG. 9).

At decision block 1330, it is determined whether a rule evaluation result message (e.g., a reply) has been received (e.g., from the rules evaluator). If so, processing continues with block 1335; otherwise processing loops back to decision block 1330 to await the rule evaluation result. As noted above, in one embodiment, a timeout mechanism may be used when a request is sent to the rule evaluator. If a request times out, the coordinator may perform a roll-back or roll-forward as appropriate.

At block 1335, the appropriate next step is determined based on the rule evaluation result and a checkpoint is created in a cluster-wide log to facilitate failure recovery. With respect to determining the appropriate next step, when a risk has been identified as being associated with the EMS event at issue by the rule evaluator and a remediation has been returned as part of the rule evaluation result (e.g., as part of a stateful EMS event), then the event and the associated corrective action may be brought to the attention of an administrative user of the cluster by creating an EMS alert that is displayed via a user interface of a system manager dashboard (e.g., as described an illustrated with reference to FIGS. 5-8).

At decision block 1345, it is determined whether remediation execution is to be performed. In the context of the present example, while no indication is received regarding remediation execution, processing loops back to decision block 1345. Responsive to the administrative user dismissing the alert displayed via the system manager dashboard (e.g., by selecting the “Dismiss” button), resulting in invocation of an auto-healing REST API (e.g., the auto-healing REST API 910 of FIG. 9), remediation execution may be skipped and processing branches to decision block 1310 to await notification of a subsequent EMS event. If the identified risk is set to be fully automated or responsive to the administrative user authorizing the remediation to be performed (e.g., by selecting the “Fix It” button), resulting in invocation of the auto-healing REST API, remediation execution may commence by continuing with decision block 1350.

At decision block 1350, one or more remediation pre-checks may be performed. If all pre-checks pass, processing continues with block 1355; otherwise, processing loops back to decision block 1310 to await receipt of another EMS event. In one embodiment, the one or more remediation pre-checks may include performing a check regarding whether a mapping exists for the rule ID to a corresponding remediation ID of a remediation to be executed. If no mapping is found, the pre-checks may be treated as having failed. Alternatively, or additionally the one or more remediation pre-checks may include performing a check to determine whether an entry exists in a task table (e.g., the cluster-wide task table 912 of FIG. 9) for the rule and/or remediation at issue (e.g., based on one or both of the rule ID and the remediation ID). If so, the remediation is already in process for this risk and the pre-checks may be treated as having failed.

At block 1355, the remediation(s) to be executed are extracted. For example, the coordinator may determine (e.g., with reference to the rules tables) the remediation ID to which the rule ID of the EMS event at issue maps.

At block 1360, a checkpoint may be created within the cluster-wide log (e.g., including the rule ID, the event ID, and the remediation ID) and execution of the remediation(s) may be requested, for example, by posting a remediation execution request message (including the remediation ID, and optionally the node ID to which the remediation execution is being delegated if the remediation execution is not to be performed by the primary node) may be posted to a pub/sub topic (e.g., a pub/sub “remediate” topic) to trigger execution of the remediation actions associated with the remediation ID by a task execution engine (e.g., the task execution engine 970 of FIG. 9).

At decision block 1365, it is determined whether a remediation status update has been received (e.g., from the task execution engine). If so, processing continues with block 1370; otherwise, processing loops back to decision block 1365 to await the remediation status update. As noted above, in one embodiment, a timeout mechanism may be used when a request is sent to the task execution engine. If a request times out, the coordinator may perform a roll-back or roll-forward as appropriate.

At block 1370, responsive to the remediation status update, the status of the remediation is updated within the cluster-wide task table and via an EMS service (e.g., the EMS service 920 of FIG. 9) so as to provide feedback to the administrative user, for example, via the user interface of the service manager dashboard.

At decision block 1375, it is determined whether a remediation reply has been received from the task execution engine that is indicative of completion of a given remediation execution. If so, processing continues with block 1380; otherwise, processing loops back to decision block 1375 to await the remediation reply. As noted above, in one embodiment, a timeout mechanism may be used when a request is sent to the task execution engine. If a request times out, the coordinator may perform a roll-back or roll-forward as appropriate.

At block 1380, responsive to the remediation reply update, the status of the remediation is updated (e.g., to a terminal state) within the cluster-wide task table and via the EMS service.

### Example Rule Execution

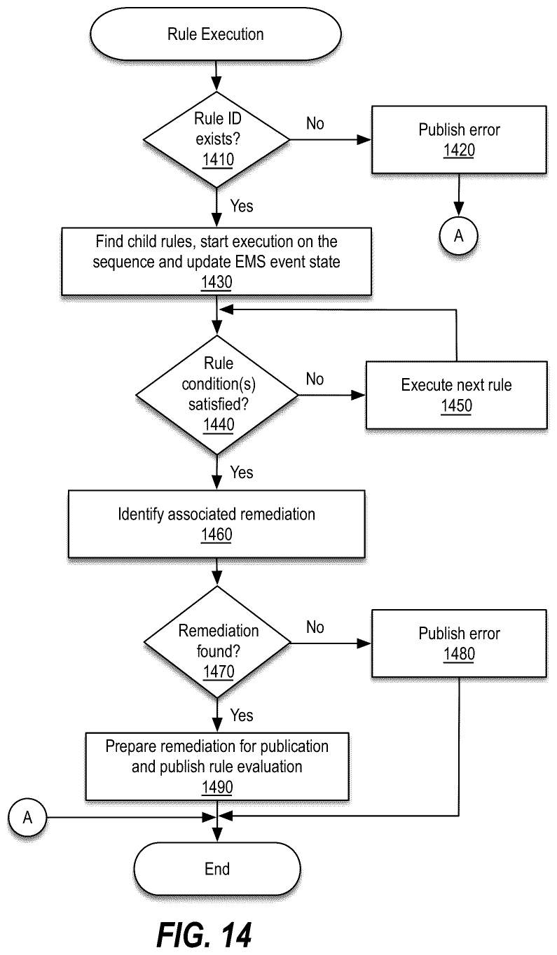

FIG. 14 is a flow diagram illustrating as set of operations for performing rule execution in accordance with one or more embodiments. The processing described with reference to FIG. 14 may represent an example of processing performed by a rule evaluator (e.g., the rule evaluator 960 of FIG. 9 or an instance of a rule evaluator running on another node of the cluster). In the context of the present example, it is assumed a coordinator (e.g., the rule/remediation coordinator 940 of FIG. 9) has previously published a rule execution request message (including a rule ID) to a pub/sub topic (e.g., a pub/sub “evaluate” topic) and rule evaluator processing has been triggered responsive to a notification by the pub/sub bus responsive to the rule execution request message.

At decision block 1410, a determination is made regarding whether the rule ID contained within the rule execution request message exists. If so, processing continues with block 1430; otherwise, processing branches to block 1420 in which an error may be published. In one embodiment, the rule evaluator may consult a rules table (e.g., the rules tables 911 of FIG. 9) to make this determination and/or arrive at this determination as a result of a corresponding folder or file for the rule at issue being missing or corrupted.

At block 1430, execution of a sequence of rules is initiated by finding child rules of the rule ID at issue. For example, rule execution logic (e.g., the logic controller 961 of FIG. 9) associated with the rule evaluator may retrieve the rule ID and the corresponding rule for each of a set of zero or more child rules associated with the rule ID at issue from the rules table and begin sequentially evaluating and executing them as appropriate. Additionally, the EMS event state may be updated to provide feedback to the administrative user of the cluster via the system manager dashboard, for example.

At decision block 1440, it is determined whether any specified rule conditions are satisfied for a given child rule. If all rule conditions are satisfied, processing continues with block 1460; otherwise, processing branches to block 1450 to skip the current child rule and move on to the next child rule after looping back to decision block 1440.

At block 1460, the associated remediation is identified, for example, with reference to a remediation ID associated with the rule ID at issue as indicated in the rules table.

At decision block 1470, it is determined whether the remediation was found. If so, processing continues with block 1490; otherwise, processing branches to block 1480 in which an error may be published. In one embodiment, the rule evaluator may consult the rules tables to make this determination and/or arrive at this determination as a result of a corresponding folder or file for the remediation at issue being missing or corrupted.

At block 1490, the remediation is prepared for publication, for example, by creating the remediation URL and associated parameters; and then, the “reply” (e.g., to the rule execution request message that initiated this process) may be posted/published, for example, in the form of a stateful EMS event via the EMS service to communicate to the coordinator the results of the rule evaluation.

### Example Remediation Execution

FIG. 15 is a flow diagram illustrating as set of operations for performing remediation execution in accordance with one or more embodiments. The processing described with reference to FIG. 15 may represent an example of processing performed by a task execution engine (e.g., the task execution engine 970 of FIG. 9 or an instance of a task execution engine running on another node of the cluster). In the context of the present example, it is assumed a coordinator (e.g., the rule/remediation coordinator 940 of FIG. 9) has previously published a remediation execution request message (including a remediation ID) to a pub/sub topic (e.g., a pub/sub “remediate” topic) and task execution engine processing has been triggered responsive to a notification by the pub/sub bus responsive to the remediation execution request message.

At decision block 1510, a determination is made regarding whether the remediation ID contained within the remediation execution request message exists. If so, processing continues with decision block 1530; otherwise, processing branches to block 1520 in which an error may be published. In one embodiment, the task execution engine may consult rules tables (e.g., rules tables 911 of FIG. 9) to make this determination and/or arrive at this determination as a result of a corresponding folder or file for the remediation at issue being missing or corrupted.

At decision block 1530, a determination may be made regarding whether the issue still exists. If so, then processing continues with block 1550; otherwise, processing branches to block 1540 in which the status of the event/issue may be updated in a cluster-wide task table (e.g., the cluster-wide task table 912 of FIG. 9) and via an EMS service (e.g., the EMS service 920 of FIG. 9) to indicate the event/issue has been remediated.

At block 1550, the associated remediation is identified. For example, task execution logic (e.g., the logic controller 971 of FIG. 9) associated with the task execution engine may attempt to locate a folder and a file associated with the remediation ID at issue.

At decision block 1560, it is determined whether the remediation was found. If so, processing continues with block 1580; otherwise, processing branches to block 1570 in which an error may be published.

At block 1580, a remediation plan is created, a remediation script is executed, and the status may be updated in the cluster-wide task table as well as via the EMS service at each step of the script.

While in the context of the examples described with reference to FIGS. 11-15, a number of enumerated blocks are included, it is to be understood that other examples may include additional blocks before, after, and/or in between the enumerated blocks. Similarly, in some examples, one or more of the enumerated blocks may be omitted and/or performed in a different order.

### Example Network Environment

FIG. 16 is a block diagram illustrating an example of a network environment 1600 in accordance with one or more embodiments. Network environment 1600 illustrates a non-limiting architecture for implementing a distributed storage system (e.g., data management storage solution 130, cluster 201, cluster 335, or a cluster of one or more of virtual storage systems 410a-c). The embodiments described above may be implemented within one or more storage apparatuses, such as any single or multiple ones of data storage apparatuses 1602a-n of FIG. 16. For example, one or more components of an auto-healing system (e.g., the auto-healing system 900 described with reference to FIG. 9) may be implemented within node computing devices 1606a-n. In one or more embodiments, nodes 102 may be implemented in a manner similar to node computing devices 1606a-n and/or data storage nodes 1610a-1610n.

Network environment 1600, which may take the form of a clustered network environment, includes data storage apparatuses 1602a-n that are coupled over a cluster or cluster fabric 1604 that includes one or more communication network(s) and facilitates communication between data storage apparatuses 1602a-n (and one or more modules, components, etc. therein, such as, node computing devices 1606a-n (also referred to as node computing devices), for example), although any number of other elements or components can also be included in network environment 1600 in other examples. This technology provides a number of advantages including methods, non-transitory computer-readable media, and computing devices that implement the techniques described herein.

In this example, node computing devices 1606a-n may be representative of primary or local storage controllers or secondary or remote storage controllers that provide client devices 1608a-n (which may also be referred to as client nodes and which may be analogous to clients 205, 305, and 405) with access to data stored within data storage nodes 1610a-n (which may also be referred to as data storage devices) and cloud storage node(s) 1636 (which may also be referred to as cloud storage device(s) and which may be analogous to hyperscale disks 425). The node computing devices 1606a-nmay be implemented as hardware, software (e.g., a storage virtual machine), or combination thereof.

Data storage apparatuses 1602a-n and/or node computing devices 1606a-n of the examples described and illustrated herein are not limited to any particular geographic areas and can be clustered locally and/or remotely via a cloud network, or not clustered in other examples. Thus, in one example data storage apparatuses 1602a-n and/or node computing devices 1606a-n can be distributed over multiple storage systems located in multiple geographic locations (e.g., located on-premise, located within a cloud computing environment, etc.); while in another example a network can include data storage apparatuses 1602a-n and/or node computing devices 1606a-n residing in the same geographic location (e.g., in a single on-site rack).

In the illustrated example, one or more of client devices 1608a-n, which may be, for example, personal computers (PCs), computing devices used for storage (e.g., storage servers), or other computers or peripheral devices, are coupled to the respective data storage apparatuses 1602a-n by network connections 1612a-n. Network connections 1612a-nmay include a local area network (LAN) or wide area network (WAN) (i.e., a cloud network), for example, that utilize TCP/IP and/or one or more Network Attached Storage (NAS) protocols, such as a Common Internet Filesystem (CIFS) protocol or a Network Filesystem (NFS) protocol to exchange data packets, a Storage Area Network (SAN) protocol, such as Small Computer System Interface (SCSI) or Fiber Channel Protocol (FCP), an object protocol, such as simple storage service (S3), and/or non-volatile memory express (NVMe), for example.

Illustratively, client devices 1608a-n may be general-purpose computers running applications and may interact with data storage apparatuses 1602a-n using a client/server model for exchange of information. That is, client devices 1608a-n may request data from data storage apparatuses 1602a-n (e.g., data on one of the data storage nodes 1610a-n managed by a network storage controller configured to process I/O commands issued by client devices 1608a-n, and data storage apparatuses 1602a-n may return results of the request to client devices 1608a-n via the network connections 1612a-n.

The node computing devices 1606a-n of data storage apparatuses 1602a-n can include network or host nodes that are interconnected as a cluster to provide data storage and management services, such as to an enterprise having remote locations, cloud storage (e.g., a storage endpoint may be stored within cloud storage node(s) 1636), etc., for example. Such node computing devices 1606a-n can be attached to the cluster fabric 1604 at a connection point, redistribution point, or communication endpoint, for example. One or more of the node computing devices 1606a-n may be capable of sending, receiving, and/or forwarding information over a network communications channel, and could comprise any type of device that meets any or all of these criteria.

In an example, the node computing devices 1606a-n may be configured according to a disaster recovery configuration whereby a surviving node provides switchover access to the storage devices 1610a-n in the event a disaster occurs at a disaster storage site (e.g., the node computing device 1606a provides client device 1608n with switchover data access to data storage nodes 1610n in the event a disaster occurs at the second storage site). In other examples, the node computing device 1606n can be configured according to an archival configuration and/or the node computing devices 1606a-n can be configured based on another type of replication arrangement (e.g., to facilitate load sharing). Additionally, while two node computing devices are illustrated in FIG. 16, any number of node computing devices or data storage apparatuses can be included in other examples in other types of configurations or arrangements.

As illustrated in network environment 1600, node computing devices 1606a-n can include various functional components that coordinate to provide a distributed storage architecture. For example, the node computing devices 1606a-n can include network modules 1614a-n and disk modules 1616a-n. Network modules 1614a-n can be configured to allow the node computing devices 1606a-n (e.g., network storage controllers) to connect with client devices 1608a-n over the network connections 1612a-n, for example, allowing client devices 1608a-n to access data stored in network environment 1600.

Further, the network modules 1614a-n can provide connections with one or more other components through the cluster fabric 1604. For example, the network module 1614a of node computing device 1606a can access the data storage node 1610n by sending a request via the cluster fabric 1604 through the disk module 1616n of node computing device 1606n when the node computing device 1606n is available. Alternatively, when the node computing device 1606n fails, the network module 1614a of node computing device 1606a can access the data storage node 1610n directly via the cluster fabric 1604. The cluster fabric 1604 can include one or more local and/or wide area computing networks (e.g., cloud networks) embodied as Infiniband, Fibre Channel (FC), or Ethernet networks, for example, although other types of networks supporting other protocols can also be used.

Disk modules 1616a-n can be configured to connect data storage nodes 1610a-n, such as disks or arrays of disks, SSDs, flash memory, or some other form of data storage, to the node computing devices 1606a-n. Often, disk modules 1616a-n communicate with the data storage nodes 1610a-n according to a SAN protocol, such as SCSI or FCP, for example, although other protocols can also be used. Thus, as seen from an OS on node computing devices 1606a-n, the data storage nodes 1610a-n can appear as locally attached. In this manner, different node computing devices 1606a-n, etc. may access data blocks, files, or objects through the OS, rather than expressly requesting abstract files.

While network environment 1600 illustrates an equal number of network modules 1614a-n and disk modules 1616a-n, other examples may include a differing number of these modules. For example, there may be a plurality of network and disk modules interconnected in a cluster that do not have a one-to-one correspondence between the network and disk modules. That is, different node computing devices can have a different number of network and disk modules, and the same node computing device can have a different number of network modules than disk modules.

Further, one or more of client devices 1608a-n can be networked with the node computing devices 1606a-n in the cluster, over the network connections 1612a-n. As an example, respective client devices 1608a-n that are networked to a cluster may request services (e.g., exchanging of information in the form of data packets) of node computing devices 1606a-n in the cluster, and the node computing devices 1606a-n can return results of the requested services to client devices 1608a-n. In one example, client devices 1608a-n can exchange information with the network modules 1614a-n residing in the node computing devices 1606a-n (e.g., network hosts) in data storage apparatuses 1602a-n.

In one example, storage apparatuses 1602a-n host aggregates corresponding to physical local and remote data storage devices, such as local flash or disk storage in the data storage nodes 1610a-n, for example. One or more of the data storage nodes 1610a-n can include mass storage devices, such as disks of a disk array. The disks may comprise any type of mass storage devices, including but not limited to magnetic disk drives, flash memory, and any other similar media adapted to store information, including, for example, data and/or parity information.

The aggregates may include volumes 1618a-n in this example, although any number of volumes can be included in the aggregates. The volumes 1618a-n are virtual data stores or storage objects that define an arrangement of storage and one or more filesystems within network environment 1600. Volumes 1618a-n can span a portion of a disk or other storage device, a collection of disks, or portions of disks, for example, and typically define an overall logical arrangement of data storage. In one example volumes 1618a-n can include stored user data as one or more files, blocks, or objects that may reside in a hierarchical directory structure within the volumes 1618a-n.

Volumes 1618a-n are typically configured in formats that may be associated with particular storage systems, and respective volume formats typically comprise features that provide functionality to the volumes 1618a-n, such as providing the ability for volumes 1618a-n to form clusters, among other functionality. Optionally, one or more of the volumes 1618a-n can be in composite aggregates and can extend between one or more of the data storage nodes 1610a-n and one or more of the cloud storage node(s) 1636 to provide tiered storage, for example, and other arrangements can also be used in other examples.

In one example, to facilitate access to data stored on the disks or other structures of the data storage nodes 1610a-n, a filesystem (e.g., file system layer 411) may be implemented that logically organizes the information as a hierarchical structure of directories and files. In this example, respective files may be implemented as a set of disk blocks of a particular size that are configured to store information, whereas directories may be implemented as specially formatted files in which information about other files and directories are stored.

Data can be stored as files or objects within a physical volume and/or a virtual volume, which can be associated with respective volume identifiers. The physical volumes correspond to at least a portion of physical storage devices, such as the data storage nodes 1610a-n (e.g., a RAID system, such as RAID layer 413) whose address, addressable space, location, etc. does not change. Typically, the location of the physical volumes does not change in that the range of addresses used to access it generally remains constant.

Virtual volumes, in contrast, can be stored over an aggregate of disparate portions of different physical storage devices. Virtual volumes may be a collection of different available portions of different physical storage device locations, such as some available space from disks, for example. It will be appreciated that since the virtual volumes are not “tied” to any one particular storage device, virtual volumes can be said to include a layer of abstraction or virtualization, which allows it to be resized and/or flexible in some regards.

Further, virtual volumes can include one or more LUNs, directories, Qtrees, files, and/or other storage objects, for example. Among other things, these features, but more particularly the LUNs, allow the disparate memory locations within which data is stored to be identified, for example, and grouped as data storage unit. As such, the LUNs may be characterized as constituting a virtual disk or drive upon which data within the virtual volumes is stored within an aggregate. For example, LUNs are often referred to as virtual drives, such that they emulate a hard drive, while they actually comprise data blocks stored in various parts of a volume.

In one example, the data storage nodes 1610a-n can have one or more physical ports, wherein each physical port can be assigned a target address (e.g., SCSI target address). To represent respective volumes, a target address on the data storage nodes 1610a-n can be used to identify one or more of the LUNs. Thus, for example, when one of the node computing devices 1606a-n connects to a volume, a connection between the one of the node computing devices 1606a-n and one or more of the LUNs underlying the volume is created.

Respective target addresses can identify multiple of the LUNs, such that a target address can represent multiple volumes. The I/O interface, which can be implemented as circuitry and/or software in a storage adapter or as executable code residing in memory and executed by a processor, for example, can connect to volumes by using one or more addresses that identify the one or more of the LUNs.

The present embodiments can take the form of an entirely hardware embodiment, an entirely software embodiment, or an embodiment containing both hardware and software elements. Accordingly, it is understood that any operation of the computing systems of the network environment 1600 and the distributed storage system may be implemented by a computing system using corresponding instructions stored on or in a non-transitory computer-readable medium accessible by a processing system. For the purposes of this description, a non-transitory computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

### Example Computer System

Various components of the present embodiments described herein may include hardware, software, or a combination thereof. Accordingly, it is to be understood operation of a distributed storage management system (e.g., data management storage solution 130, cluster 201, cluster 335, or a cluster of one or more of virtual storage systems 410a-c) or one or more of components thereof may be implemented using a computing system via corresponding instructions stored on or in a non-transitory computer-readable medium accessible by a processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

The various systems and subsystems (e.g., file system layer 411, RAID layer 413, and storage layer 415), and/or nodes 102 (when represented in virtual form) of the distributed storage system described herein, and the processing described herein may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems (e.g., servers, network storage systems or appliances, blades, etc.) of various forms, such as the computer system described with reference to FIG. 17 below.

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 17 is a block diagram that illustrates a computer system 1700 in which or with which an embodiment of the present disclosure may be implemented. Computer system 1700 may be representative of all or a portion of the computing resources associated with a node of nodes 102 of a distributed storage system (e.g., cluster 201, cluster 335, or a cluster including virtual storage systems 410a-c). Notably, components of computer system 1700 described herein are meant only to exemplify various possibilities. In no way should example computer system 1700 limit the scope of the present disclosure. In the context of the present example, computer system 1700 includes a bus 1702 or other communication mechanism for communicating information, and a processing resource (e.g., a hardware processor 1704) coupled with bus 1702 for processing information. Hardware processor 1704 may be, for example, a general-purpose microprocessor.

Computer system 1700 also includes a main memory 1706, such as a random-access memory (RAM) or other dynamic storage device, coupled to bus 1702 for storing information and instructions to be executed by processor 1704. Main memory 1706 also may be used for storing temporary variables or other intermediate information during execution of instructions to be executed by processor 1704. Such instructions, when stored in non-transitory storage media accessible to processor 1704, render computer system 1700 into a special-purpose machine that is customized to perform the operations specified in the instructions.

Computer system 1700 further includes a read only memory (ROM) 1708 or other static storage device coupled to bus 1702 for storing static information and instructions for processor 1704. A storage device 1710, e.g., a magnetic disk, optical disk or flash disk (made of flash memory chips), is provided and coupled to bus 1702 for storing information and instructions.

Computer system 1700 may be coupled via bus 1702 to a display 1712, e.g., a cathode ray tube (CRT), Liquid Crystal Display (LCD), Organic Light-Emitting Diode Display (OLED), Digital Light Processing Display (DLP) or the like, for displaying information to a computer user. An input device 1714, including alphanumeric and other keys, is coupled to bus 1702 for communicating information and command selections to processor 1704. Another type of user input device is cursor control 1716, such as a mouse, a trackball, a trackpad, or cursor direction keys for communicating direction information and command selections to processor 1704 and for controlling cursor movement on display 1712. This input device typically has two degrees of freedom in two axes, a first axis (e.g., x) and a second axis (e.g., y), that allows the device to specify positions in a plane.

Removable storage media 1740 can be any kind of external storage media, including, but not limited to, hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), USB flash drives and the like.

Computer system 1700 may implement the techniques described herein using customized hard-wired logic, one or more ASICs or FPGAs, firmware or program logic which in combination with the computer system causes or programs computer system 1700 to be a special-purpose machine. According to one embodiment, the techniques herein are performed by computer system 1700 in response to processor 1704 executing one or more sequences of one or more instructions contained in main memory 1706. Such instructions may be read into main memory 1706 from another storage medium, such as storage device 1710. Execution of the sequences of instructions contained in main memory 1706 causes processor 1704 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1710. Volatile media includes dynamic memory, such as main memory 1706. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1702. Transmission media can also take the form of acoustic or light waves, such as those generated during radio-wave and infra-red data communications.

Various forms of media may be involved in carrying one or more sequences of one or more instructions to processor 1704 for execution. For example, the instructions may initially be carried on a magnetic disk or solid-state drive of a remote computer. The remote computer can load the instructions into its dynamic memory and send the instructions over a telephone line using a modem. A modem local to computer system 1700 can receive the data on the telephone line and use an infra-red transmitter to convert the data to an infra-red signal. An infra-red detector can receive the data carried in the infra-red signal and appropriate circuitry can place the data on bus 1702. Bus 1702 carries the data to main memory 1706, from which processor 1704 retrieves and executes the instructions. The instructions received by main memory 1706 may optionally be stored on storage device 1710 either before or after execution by processor 1704.

Computer system 1700 also includes a communication interface 1718 coupled to bus 1702. Communication interface 1718 provides a two-way data communication coupling to a network link 1720 that is connected to a local network 1722. For example, communication interface 1718 may be an integrated services digital network (ISDN) card, cable modem, satellite modem, or a modem to provide a data communication connection to a corresponding type of telephone line. As another example, communication interface 1718 may be a local area network (LAN) card to provide a data communication connection to a compatible LAN. Wireless links may also be implemented. In any such implementation, communication interface 1718 sends and receives electrical, electromagnetic or optical signals that carry digital data streams representing various types of information.

Network link 1720 typically provides data communication through one or more networks to other data devices. For example, network link 1720 may provide a connection through local network 1722 to a host computer 1724 or to data equipment operated by an Internet Service Provider (ISP) 1726. ISP 1726 in turn provides data communication services through the worldwide packet data communication network now commonly referred to as the “Internet” 1728. Local network 1722 and Internet 1728 both use electrical, electromagnetic or optical signals that carry digital data streams. The signals through the various networks and the signals on network link 1720 and through communication interface 1718, which carry the digital data to and from computer system 1700, are example forms of transmission media.

Computer system 1700 can send messages and receive data, including program code, through the network(s), network link 1720 and communication interface 1718. In the Internet example, a server 1730 might transmit a requested code for an application program through Internet 1728, ISP 1726, local network 1722 and communication interface 1718. The received code may be executed by processor 1704 as it is received, or stored in storage device 1710, or other non-volatile storage for later execution.

All examples and illustrative references are non-limiting and should not be used to limit any claims presented herein to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A non-transitory machine readable medium storing instructions, which when executed by one or more processing resource of a data storage system, cause the data storage system to:
determine existence of a risk to which the data storage system is exposed by evaluating conditions associated with a set of one or more rules that are indicative of a root cause of the risk, wherein the set of one or more rules are part of a rule set that is derived at least in part based on community wisdom applicable to the data storage system;
identify existence of a remediation associated with the risk that addresses or mitigates the risk; and
execute one or more remediation actions that implement the remediation.

2. The non-transitory machine readable medium of claim 1, wherein the instructions further cause the data storage system to receive an update or an addition to the rule set out-of-cycle with a release schedule for software of the data storage system.

3. The non-transitory machine readable medium of claim 2, wherein the rule set is derived at least in part based on telemetry data periodically received by a vendor of the data storage system from a same or similar data storage system of the vendor that is utilized by a community of users.

4. The non-transitory machine readable medium of claim 1, wherein the instructions further cause the data storage system to receive an update to a remediation set of which the remediation is a part out-of-cycle with a release schedule for software of the data storage system.

5. The non-transitory machine readable medium of claim 4, wherein the remediation set is derived at least in part based on telemetry data periodically received by a vendor of the data storage system from data storage systems of the vendor of a same or similar class and type of the data storage system that are utilized by a community of users.

6. The non-transitory machine readable medium of claim 1, wherein the risk represents a misconfiguration of the data storage system, an issue associated with an environment in which the data storage system operates that might impact the data storage system, a security issue relating to the data storage system, a performance issue relating to the data storage system, a compliance issue relating to the data storage system, or a capacity issue relating to the data storage system.

7. The non-transitory machine readable medium of claim 1, wherein determining the existence of the risk is performed responsive to an occurrence within the data storage system of an event of a predefined or configurable set of event management system (EMS) events.

8. The non-transitory machine readable medium of claim 7, wherein the instructions further cause the data storage system to maintain a mapping of each event of the predefined or configurable set of EMS events to a corresponding set of one or more rules to be evaluated.

9. The non-transitory machine readable medium of claim 1, wherein determining the existence of the risk is performed in accordance with a predefined or configurable schedule.

10. The non-transitory machine readable medium of claim 1, wherein the instructions further cause the data storage system to determine whether the remediation is to be automatically performed based on configured preferences relating to a desired type of remediation or based on one or more historical interactions with an administrative user of the data storage system regarding performance of the remediation to address the risk or a similar risk.

11. The non-transitory machine readable medium of claim 10, wherein the instructions further cause the data storage system to responsive to determining the remediation is to be automatically performed, perform execution of the one or more remediation actions without requiring receipt of explicit authorization to perform the remediation from the administrative user.

12. A method comprising:
determining existence of a risk to which a data storage system is exposed by evaluating conditions associated with a set of one or more rules that are indicative of a root cause of the risk, wherein the set of one or more rules are part of a rule set that is derived at least in part based on community wisdom applicable to the data storage system;
identifying existence of a remediation associated with the risk that addresses or mitigates the risk; and
executing one or more remediation actions that implement the remediation.

13. The method of claim 12, further comprising receiving an update or an addition to one or both of the rule set and a remediation set of which the remediation is a part out-of-cycle with a release schedule for software of the data storage system.

14. The method of claim 13, wherein one or both of the rule set and the remediation set are derived at least in part based on telemetry data periodically received by a vendor of the data storage system from a same or similar data storage system of the vendor that is utilized by a community of users.

15. The method of claim 12, wherein the risk represents a misconfiguration of the data storage system, an issue associated with an environment in which the data storage system operates that might impact the data storage system, a security issue relating to the data storage system, a performance issue relating to the data storage system, a compliance issue relating to the data storage system, or a capacity issue relating to the data storage system.

16. The method of claim 12, wherein said determining is performed responsive to an occurrence within the data storage system of an event of a predefined or configurable set of event management system (EMS) events.

17. The method of claim 1, further comprising:
determining whether the remediation is to be automatically performed based on configured preferences relating to a desired type of remediation or based on one or more historical interactions with an administrative user of the data storage system regarding performance of the remediation to address the risk or a similar risk; and
responsive to determining the remediation is to be automatically performed, performing said executing one or more remediation actions without requiring receipt of explicit authorization to perform the remediation from the administrative user.

18. A data storage system comprising:
one or more processing resources; and
instructions that when executed by the one or more processing resources cause the data storage system to:
determine existence of a risk to which the data storage system is exposed by evaluating conditions associated with a set of one or more rules that are indicative of a root cause of the risk, wherein the set of one or more rules are part of a rule set that is derived at least in part based on community wisdom applicable to the data storage system;
identify existence of a remediation associated with the risk that addresses or mitigates the risk; and
execute one or more remediation actions that implement the remediation.

19. The data storage system of claim 18, wherein the instructions further cause the data storage system to receive an update or an addition to one or both of the rule set and a remediation set of which the remediation is a part out-of-cycle with a release schedule for software of the data storage system.

20. The data storage system of claim 18, wherein one or both of the rule set and the remediation set are derived at least in part based on telemetry data periodically received by a vendor of the data storage system from a same or similar data storage system of the vendor that is utilized by a community of users.
